(19) United States
(12) Patent Application Publication
(10) Pub. No.: US 2024/0069169 A1
(43) Pub. Date: Feb. 29, 2024

(54) FILM ELECTROMAGNETIC MIRROR

(71) Applicant: Innovusion, Inc., Sunnyvale, CA (US)

(72) Inventors: Haosen Wang, Sunnyvale, CA (US); Yimin Li, Cupertino, CA (US)

(73) Assignee: Innovusion, Inc., Sunnyvale, CA (US)

(21) Appl. No.: 18/237,359

(22) Filed: Aug. 23, 2023

Related U.S. Application Data
(60) Provisional application No. 63/401,988, filed on Aug. 29, 2022.

(51) Int. Cl. G01S 7/481; G01S 17/89; G01S 17/931

(52) U.S. Cl. CPC G01S 7/4817; G01S 7/4814; G01S 17/89; G01S 17/931

(57) ABSTRACT

An electromagnetically-moveable scanner device for performing light scan used in a light ranging and detection (LiDAR) system is provided. The device comprises a platform, which comprises a film substrate. The platform is pivotable about an axis. The device further comprises a reflector disposed on the platform, a plurality of magnets disposed in proximity to one or more edges of the film substrate and detached therefrom, and one or more electrical windings installed on the platform. At least a part of the electrical windings is disposed underneath the reflector. When the one or more electrical windings carry electric current, an interaction between magnetic fields formed by the plurality of the magnets and the electrical windings is operative to move the reflector electromagnetically to scan a field-of-view along at least one direction.

### CROSS-REFERENCE TO RELATED APPLICATIONS

This application claims priority to U.S. Provisional Patent Application Ser. No. 63/401,988, filed Aug. 29, 2022, entitled “Film Electromagnetic Mirror,” the content of which is hereby incorporated by reference in its entirety for all purposes.

### FIELD OF THE TECHNOLOGY

This disclosure relates generally to optical scanning and, more particularly, to an electromagnetically-moveable scanner device for performing light scan used in a light ranging and detection (LiDAR) system.

### BACKGROUND

Light detection and ranging (LiDAR) systems use light pulses to create an image or point cloud of the external environment. A LiDAR system may be a scanning or non-scanning system. Some typical scanning LiDAR systems include a light source, a light transmitter, a light steering system, and a light detector. The light source generates a light beam that is directed by the light steering system in particular directions when being transmitted from the LiDAR system. When a transmitted light beam is scattered or reflected by an object, a portion of the scattered or reflected light returns to the LiDAR system to form a return light pulse. The light detector detects the return light pulse. Using the difference between the time that the return light pulse is detected and the time that a corresponding light pulse in the light beam is transmitted, the LiDAR system can determine the distance to the object based on the speed of light. This technique of determining the distance is referred to as the time-of-flight (ToF) technique. The light steering system can direct light beams along different paths to allow the LiDAR system to scan the surrounding environment and produce images or point clouds. A typical non-scanning LiDAR system illuminate an entire field-of-view (FOV) rather than scanning through the FOV. An example of the non-scanning LiDAR system is a flash LiDAR, which can also use the ToF technique to measure the distance to an object. LiDAR systems can also use techniques other than time-of-flight and scanning to measure the surrounding environment.

### SUMMARY

Micro-electromechanical systems (MEMS) mirrors have been used for LiDAR systems to steer laser beams. There are different kinds of MEMS mirrors. Electromagnetic MEMS mirrors use Lorentz force produced by electrical current flowing in magnetic fields to control the movement of the mirror. Electrostatic MEMS mirrors use electrostatic forces to control the movement of the mirror. There are also piezoelectric MEMS mirrors and various other kinds of MEMS mirrors.

In traditional MEMS mirrors, silicon wafers are commonly used as substrates. However, this approach presents two significant problems. The first problem relates to the reliability of silicon-based MEMS mirrors. As a solid-state material, silicon wafer is fragile. Extended rotation and vibration of the silicon substrate, especially under high intensity and frequency, can result in fatigue and eventual damage to the mirror. The second problem pertains to the size limitations of silicon-based MEMS mirrors. These mirrors are typically designed in smaller sizes, as larger rotating mirrors become more prone to damage due to the reliability problem. Moreover, cost considerations exacerbate the size constraint. Manufacturing silicon-based MEMS mirrors on silicon wafers requires achieving high yield, due to the costly nature of silicon wafers. Thus, silicon-based MEMS chips are usually designed to be smaller in size to attain a higher yield. For instance, a typical silicon-based MEMS mirror has a diameter of no more than 7 millimeters. However, in LiDAR systems, larger scanning mirrors are generally preferable. One reason for this preference is that larger scanning mirrors provide larger optical aperture and improved light directing and collection capabilities. With larger scanning mirrors, the LiDAR system can have extended scanning distances, and the LiDAR receiver can detect weaker light signals from greater distances.

The two aforementioned problems give rise to a paradox concerning the utilization of MEMS mirrors in LiDAR systems. From the standpoint of cost and reliability, it is advantageous to maintain smaller-sized MEMS mirrors. However, from a LiDAR functionality perspective, larger MEMS mirrors are favored to enhance the system's scanning capabilities. To resolve this paradox, a solution could be to adopt a strengthened MEMS mirror substrate that can achieve comparable functions and features to those of silicon-based MEMS mirrors.

Embodiments of the present invention discloses a novel film electromagnetic mirror solution. In one example, the mirror does not use silicon-based substrates, but metal-based substrates. This solution allows for the mirror size to be expanded to one inch or even larger, offering substantial advantages over the limitations of smaller silicon-based MEMS mirrors. It is to be noted that while the present disclosure centers around electromagnetic MEMS mirrors, the solution can be extended to other types of MEMS mirrors.

In one embodiment, an electromagnetically-moveable scanner device for performing light scan used in a LiDAR system is provided. The device comprises a platform, which comprises a film substrate. The platform is pivotable about an axis. The device further comprises a reflector disposed on the platform, a plurality of magnets disposed in proximity to one or more edges of the film substrate and detached therefrom, and one or more electrical windings installed on the platform. At least a part of the electrical windings is disposed underneath the reflector. When the one or more electrical windings carry electric current, an interaction between magnetic fields formed by the plurality of the magnets and the electrical windings is operative to move the reflector electromagnetically to scan a field-of-view along at least one direction.

### BRIEF DESCRIPTION OF THE DRAWINGS

The present application can be best understood by reference to the embodiments described below taken in conjunction with the accompanying drawing figures, in which like parts may be referred to by like numerals.

FIG. 1 illustrates one or more example LiDAR systems disposed or included in a motor vehicle.

FIG. 2 is a block diagram illustrating interactions between an example LiDAR system and multiple other systems including a vehicle perception and planning system.

FIG. 3 is a block diagram illustrating an example LiDAR system.

FIG. 4 is a block diagram illustrating an example fiber-based laser source.

FIGS. 5A-5C illustrate an example LiDAR system using pulse signals to measure distances to objects disposed in a field-of-view (FOV).

FIG. 6 is a block diagram illustrating an example apparatus used to implement systems, apparatus, and methods in various embodiments.

FIG. 7 illustrates Lorentz forces experienced by a current-carrying conductor in a magnetic field.

FIG. 8A illustrates an exemplary MEMS mirror apparatus according to one embodiment.

FIG. 8B illustrates an exemplary two-dimensional MEMS mirror apparatus according to one embodiment.

FIG. 9A illustrates a top view of an exemplary MEMS mirror apparatus according to one embodiment.

FIG. 9B illustrates a cross-sectional view of an exemplary MEMS mirror apparatus according to one embodiment.

FIG. 10A is a block diagram illustrating an exemplary arrangement of components in a steering mechanism of a LiDAR system according to one embodiment.

FIG. 10B is a block diagram illustrating an exemplary arrangement of components in another steering mechanism of a LiDAR system according to one embodiment.

### DETAILED DESCRIPTION

To provide a more thorough understanding of various embodiments of the present invention, the following description sets forth numerous specific details, such as specific configurations, parameters, examples, and the like. It should be recognized, however, that such description is not intended as a limitation on the scope of the present invention but is intended to provide a better description of the exemplary embodiments.

Throughout the specification and claims, the following terms take the meanings explicitly associated herein, unless the context clearly dictates otherwise:

The phrase “in one embodiment” as used herein does not necessarily refer to the same embodiment, though it may. Thus, as described below, various embodiments of the disclosure may be readily combined, without departing from the scope or spirit of the invention.

As used herein, the term “or” is an inclusive “or” operator and is equivalent to the term “and/or,” unless the context clearly dictates otherwise.

The term “based on” is not exclusive and allows for being based on additional factors not described unless the context clearly dictates otherwise.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Within the context of a networked environment where two or more components or devices are able to exchange data, the terms “coupled to” and “coupled with” are also used to mean “communicatively coupled with”, possibly via one or more intermediary devices. The components or devices can be optical, mechanical, and/or electrical devices.

Although the following description uses terms “first,” “second,” etc. to describe various elements, these elements should not be limited by the terms. These terms are only used to distinguish one element from another. For example, a first sensor could be termed a second sensor and, similarly, a second sensor could be termed a first sensor, without departing from the scope of the various described examples. The first sensor and the second sensor can both be sensors and, in some cases, can be separate and different sensors.

In addition, throughout the specification, the meaning of “a”, “an”, and “the” includes plural references, and the meaning of “in” includes “in” and “on”.

Although some of the various embodiments presented herein constitute a single combination of inventive elements, it should be appreciated that the inventive subject matter is considered to include all possible combinations of the disclosed elements. As such, if one embodiment comprises elements A, B, and C, and another embodiment comprises elements B and D, then the inventive subject matter is also considered to include other remaining combinations of A, B, C, or D, even if not explicitly discussed herein. Further, the transitional term “comprising” means to have as parts or members, or to be those parts or members. As used herein, the transitional term “comprising” is inclusive or open-ended and does not exclude additional, unrecited elements or method steps.

As used in the description herein and throughout the claims that follow, when a system, engine, server, device, module, or other computing element is described as being configured to perform or execute functions on data in a memory, the meaning of “configured to” or “programmed to” is defined as one or more processors or cores of the computing element being programmed by a set of software instructions stored in the memory of the computing element to execute the set of functions on target data or data objects stored in the memory.

It should be noted that any language directed to a computer should be read to include any suitable combination of computing devices or network platforms, including servers, interfaces, systems, databases, agents, peers, engines, controllers, modules, or other types of computing devices operating individually or collectively. One should appreciate the computing devices comprise a processor configured to execute software instructions stored on a tangible, non-transitory computer readable storage medium (e.g., hard drive, FPGA, PLA, solid state drive, RAM, flash, ROM, or any other volatile or non-volatile storage devices). The software instructions configure or program the computing device to provide the roles, responsibilities, or other functionality as discussed below with respect to the disclosed apparatus. Further, the disclosed technologies can be embodied as a computer program product that includes a non-transitory computer readable medium storing the software instructions that causes a processor to execute the disclosed steps associated with implementations of computer-based algorithms, processes, methods, or other instructions. In some embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges among devices can be conducted over a packet-switched network, the Internet, LAN, WAN, VPN, or other type of packet switched network; a circuit switched network; cell switched network; or other type of network.

MEMS mirrors are used in LiDAR systems for scanning. However, traditional silicon-based MEMS substrates presents challenges related to reliability and size limitations. The pursuit of larger-sized MEMS mirrors is hindered because of cost and reliability considerations. To address these issues, a novel film electromagnetic mirror is presented that offers higher mechanical strength and enables the realization of larger mirror size and extended scanning distance. This results in more robust, durable, and cost-effective MEMS mirrors for enhanced LiDAR performance.

Embodiments of present invention are described below. In various embodiments of the present invention, an electromagnetically-moveable scanner device for performing light scan used in a LiDAR system is provided. The device comprises a platform, which comprises a film substrate. The platform is pivotable about an axis. The device further comprises a reflector disposed on the platform, a plurality of magnets disposed in proximity to one or more edges of the film substrate and detached therefrom, and one or more electrical windings installed on the platform. At least a part of the electrical windings is disposed underneath the reflector. When the one or more electrical windings carry electric current, an interaction between magnetic fields formed by the plurality of the magnets and the electrical windings is operative to move the reflector electromagnetically to scan a field-of-view along at least one direction.

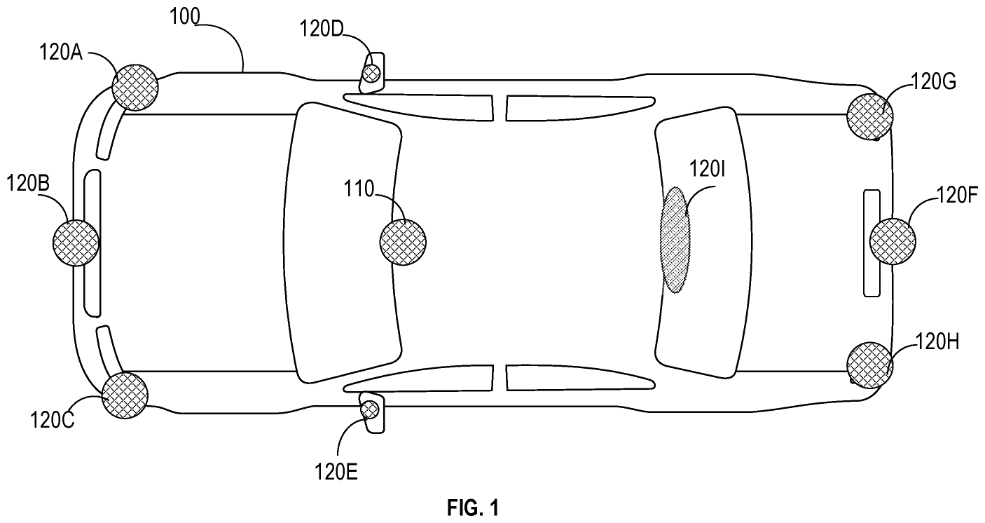

FIG. 1 illustrates one or more example LiDAR systems 110 disposed or included in a motor vehicle 100. Vehicle 100 can be a car, a sport utility vehicle (SUV), a truck, a train, a wagon, a bicycle, a motorcycle, a tricycle, a bus, a mobility scooter, a tram, a ship, a boat, an underwater vehicle, an airplane, a helicopter, a unmanned aviation vehicle (UAV), a spacecraft, etc. Motor vehicle 100 can be a vehicle having any automated level. For example, motor vehicle 100 can be a partially automated vehicle, a highly automated vehicle, a fully automated vehicle, or a driverless vehicle. A partially automated vehicle can perform some driving functions without a human driver's intervention. For example, a partially automated vehicle can perform blind-spot monitoring, lane keeping and/or lane changing operations, automated emergency braking, smart cruising and/or traffic following, or the like. Certain operations of a partially automated vehicle may be limited to specific applications or driving scenarios (e.g., limited to only freeway driving). A highly automated vehicle can generally perform all operations of a partially automated vehicle but with less limitations. A highly automated vehicle can also detect its own limits in operating the vehicle and ask the driver to take over the control of the vehicle when necessary. A fully automated vehicle can perform all vehicle operations without a driver's intervention but can also detect its own limits and ask the driver to take over when necessary. A driverless vehicle can operate on its own without any driver intervention.

In typical configurations, motor vehicle 100 comprises one or more LiDAR systems 110 and 120A-120I. Each of LiDAR systems 110 and 120A-120I can be a scanning-based LiDAR system and/or a non-scanning LiDAR system (e.g., a flash LiDAR). A scanning-based LiDAR system scans one or more light beams in one or more directions (e.g., horizontal and vertical directions) to detect objects in a field-of-view (FOV). A non-scanning based LiDAR system transmits laser light to illuminate an FOV without scanning. For example, a flash LiDAR is a type of non-scanning based LiDAR system. A flash LiDAR can transmit laser light to simultaneously illuminate an FOV using a single light pulse or light shot.

A LiDAR system is a frequently-used sensor of a vehicle that is at least partially automated. In one embodiment, as shown in FIG. 1, motor vehicle 100 may include a single LiDAR system 110 (e.g., without LiDAR systems 120A-120I) disposed at the highest position of the vehicle (e.g., at the vehicle roof). Disposing LiDAR system 110 at the vehicle roof facilitates a 360-degree scanning around vehicle 100. In some other embodiments, motor vehicle 100 can include multiple LiDAR systems, including two or more of systems 110 and/or 120A-120I. As shown in FIG. 1, in one embodiment, multiple LiDAR systems 110 and/or 120A-120I are attached to vehicle 100 at different locations of the vehicle. For example, LiDAR system 120A is attached to vehicle 100 at the front right corner; LiDAR system 120B is attached to vehicle 100 at the front center position; LiDAR system 120C is attached to vehicle 100 at the front left corner; LiDAR system 120D is attached to vehicle 100 at the right-side rear view mirror; LiDAR system 120E is attached to vehicle 100 at the left-side rear view mirror; LiDAR system 120F is attached to vehicle 100 at the back center position; LiDAR system 120G is attached to vehicle 100 at the back right corner; LiDAR system 120H is attached to vehicle 100 at the back left corner; and/or LiDAR system 120I is attached to vehicle 100 at the center towards the backend (e.g., back end of the vehicle roof). It is understood that one or more LiDAR systems can be distributed and attached to a vehicle in any desired manner and FIG. 1 only illustrates one embodiment. As another example, LiDAR systems 120D and 120E may be attached to the B-pillars of vehicle 100 instead of the rear-view mirrors. As another example, LiDAR system 120B may be attached to the windshield of vehicle 100 instead of the front bumper.

In some embodiments, LiDAR systems 110 and 120A-120I are independent LiDAR systems having their own respective laser sources, control electronics, transmitters, receivers, and/or steering mechanisms. In other embodiments, some of LiDAR systems 110 and 120A-120I can share one or more components, thereby forming a distributed sensor system. In one example, optical fibers are used to deliver laser light from a centralized laser source to all LiDAR systems. For instance, system 110 (or another system that is centrally positioned or positioned anywhere inside the vehicle 100) includes a light source, a transmitter, and a light detector, but have no steering mechanisms. System 110 may distribute transmission light to each of systems 120A-120I. The transmission light may be distributed via optical fibers. Optical connectors can be used to couple the optical fibers to each of system 110 and 120A-120I. In some examples, one or more of systems 120A-120I include steering mechanisms but no light sources, transmitters, or light detectors. A steering mechanism may include one or more moveable mirrors such as one or more polygon mirrors, one or more single plane mirrors, one or more multi-plane mirrors, or the like. Embodiments of the light source, transmitter, steering mechanism, and light detector are described in more detail below. Via the steering mechanisms, one or more of systems 120A-120I scan light into one or more respective FOVs and receive corresponding return light. The return light is formed by scattering or reflecting the transmission light by one or more objects in the FOVs. Systems 120A-120I may also include collection lens and/or other optics to focus and/or direct the return light into optical fibers, which deliver the received return light to system 110. System 110 includes one or more light detectors for detecting the received return light. In some examples, system 110 is disposed inside a vehicle such that it is in a temperature-controlled environment, while one or more systems 120A-120I may be at least partially exposed to the external environment.

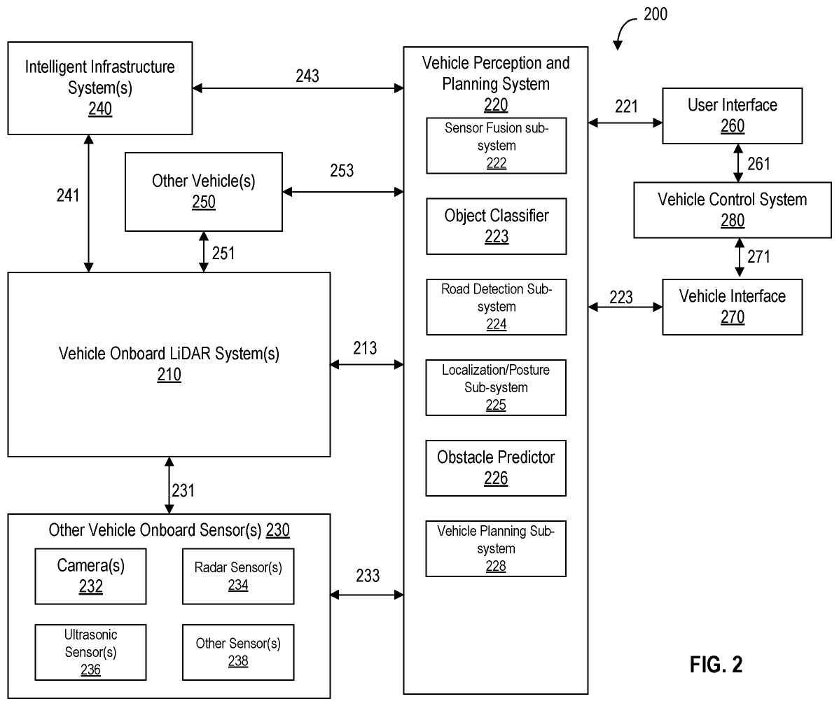

FIG. 2 is a block diagram 200 illustrating interactions between vehicle onboard LiDAR system(s) 210 and multiple other systems including a vehicle perception and planning system 220. LiDAR system(s) 210 can be mounted on or integrated to a vehicle. LiDAR system(s) 210 include sensor(s) that scan laser light to the surrounding environment to measure the distance, angle, and/or velocity of objects. Based on the scattered light that returned to LiDAR system(s) 210, it can generate sensor data (e.g., image data or 3D point cloud data) representing the perceived external environment.

LiDAR system(s) 210 can include one or more of short-range LiDAR sensors, medium-range LiDAR sensors, and long-range LiDAR sensors. A short-range LiDAR sensor measures objects located up to about 20-50 meters from the LiDAR sensor. Short-range LiDAR sensors can be used for, e.g., monitoring nearby moving objects (e.g., pedestrians crossing street in a school zone), parking assistance applications, or the like. A medium-range LiDAR sensor measures objects located up to about 70-200 meters from the LiDAR sensor. Medium-range LiDAR sensors can be used for, e.g., monitoring road intersections, assistance for merging onto or leaving a freeway, or the like. A long-range LiDAR sensor measures objects located up to about 200 meters and beyond. Long-range LiDAR sensors are typically used when a vehicle is travelling at a high speed (e.g., on a freeway), such that the vehicle's control systems may only have a few seconds (e.g., 6-8 seconds) to respond to any situations detected by the LiDAR sensor. As shown in FIG. 2, in one embodiment, the LiDAR sensor data can be provided to vehicle perception and planning system 220 via a communication path 213 for further processing and controlling the vehicle operations. Communication path 213 can be any wired or wireless communication links that can transfer data.

With reference still to FIG. 2, in some embodiments, other vehicle onboard sensor(s) 230 are configured to provide additional sensor data separately or together with LiDAR system(s) 210. Other vehicle onboard sensors 230 may include, for example, one or more camera(s) 232, one or more radar(s) 234, one or more ultrasonic sensor(s) 236, and/or other sensor(s) 238. Camera(s) 232 can take images and/or videos of the external environment of a vehicle. Camera(s) 232 can take, for example, high-definition (HD) videos having millions of pixels in each frame. A camera includes image sensors that facilitates producing monochrome or color images and videos. Color information may be important in interpreting data for some situations (e.g., interpreting images of traffic lights). Color information may not be available from other sensors such as LiDAR or radar sensors. Camera(s) 232 can include one or more of narrow-focus cameras, wider-focus cameras, side-facing cameras, infrared cameras, fisheye cameras, or the like. The image and/or video data generated by camera(s) 232 can also be provided to vehicle perception and planning system 220 via communication path 233 for further processing and controlling the vehicle operations. Communication path 233 can be any wired or wireless communication links that can transfer data. Camera(s) 232 can be mount on, or integrated to, a vehicle at any locations (e.g., rear-view mirrors, pillars, front grille, and/or back bumpers, etc.).

Other vehicle onboard sensors(s) 230 can also include radar sensor(s) 234. Radar sensor(s) 234 use radio waves to determine the range, angle, and velocity of objects. Radar sensor(s) 234 produce electromagnetic waves in the radio or microwave spectrum. The electromagnetic waves reflect off an object and some of the reflected waves return to the radar sensor, thereby providing information about the object's position and velocity. Radar sensor(s) 234 can include one or more of short-range radar(s), medium-range radar(s), and long-range radar(s). A short-range radar measures objects located at about 0.1-30 meters from the radar. A short-range radar is useful in detecting objects located nearby the vehicle, such as other vehicles, buildings, walls, pedestrians, bicyclists, etc. A short-range radar can be used to detect a blind spot, assist in lane changing, provide rear-end collision warning, assist in parking, provide emergency braking, or the like. A medium-range radar measures objects located at about 30-80 meters from the radar. A long-range radar measures objects located at about 80-200 meters. Medium- and/or long-range radars can be useful in, for example, traffic following, adaptive cruise control, and/or highway automatic braking. Sensor data generated by radar sensor(s) 234 can also be provided to vehicle perception and planning system 220 via communication path 233 for further processing and controlling the vehicle operations. Radar sensor(s) 234 can be mount on, or integrated to, a vehicle at any locations (e.g., rear-view mirrors, pillars, front grille, and/or back bumpers, etc.).

Other vehicle onboard sensor(s) 230 can also include ultrasonic sensor(s) 236. Ultrasonic sensor(s) 236 use acoustic waves or pulses to measure object located external to a vehicle. The acoustic waves generated by ultrasonic sensor(s) 236 are transmitted to the surrounding environment. At least some of the transmitted waves are reflected off an object and return to the ultrasonic sensor(s) 236. Based on the return signals, a distance of the object can be calculated. Ultrasonic sensor(s) 236 can be useful in, for example, checking blind spots, identifying parking spaces, providing lane changing assistance into traffic, or the like. Sensor data generated by ultrasonic sensor(s) 236 can also be provided to vehicle perception and planning system 220 via communication path 233 for further processing and controlling the vehicle operations. Ultrasonic sensor(s) 236 can be mount on, or integrated to, a vehicle at any locations (e.g., rear-view mirrors, pillars, front grille, and/or back bumpers, etc.).

In some embodiments, one or more other sensor(s) 238 may be attached in a vehicle and may also generate sensor data. Other sensor(s) 238 may include, for example, global positioning systems (GPS), inertial measurement units (IMU), or the like. Sensor data generated by other sensor(s) 238 can also be provided to vehicle perception and planning system 220 via communication path 233 for further processing and controlling the vehicle operations. It is understood that communication path 233 may include one or more communication links to transfer data between the various sensor(s) 230 and vehicle perception and planning system 220.

In some embodiments, as shown in FIG. 2, sensor data from other vehicle onboard sensor(s) 230 can be provided to vehicle onboard LiDAR system(s) 210 via communication path 231. LiDAR system(s) 210 may process the sensor data from other vehicle onboard sensor(s) 230. For example, sensor data from camera(s) 232, radar sensor(s) 234, ultrasonic sensor(s) 236, and/or other sensor(s) 238 may be correlated or fused with sensor data LiDAR system(s) 210, thereby at least partially offloading the sensor fusion process performed by vehicle perception and planning system 220. It is understood that other configurations may also be implemented for transmitting and processing sensor data from the various sensors (e.g., data can be transmitted to a cloud or edge computing service provider for processing and then the processing results can be transmitted back to the vehicle perception and planning system 220 and/or LiDAR system 210).

With reference still to FIG. 2, in some embodiments, sensors onboard other vehicle(s) 250 are used to provide additional sensor data separately or together with LiDAR system(s) 210. For example, two or more nearby vehicles may have their own respective LiDAR sensor(s), camera(s), radar sensor(s), ultrasonic sensor(s), etc. Nearby vehicles can communicate and share sensor data with one another. Communications between vehicles are also referred to as V2V (vehicle to vehicle) communications. For example, as shown in FIG. 2, sensor data generated by other vehicle(s) 250 can be communicated to vehicle perception and planning system 220 and/or vehicle onboard LiDAR system(s) 210, via communication path 253 and/or communication path 251, respectively. Communication paths 253 and 251 can be any wired or wireless communication links that can transfer data.

Sharing sensor data facilitates a better perception of the environment external to the vehicles. For instance, a first vehicle may not sense a pedestrian that is behind a second vehicle but is approaching the first vehicle. The second vehicle may share the sensor data related to this pedestrian with the first vehicle such that the first vehicle can have additional reaction time to avoid collision with the pedestrian. In some embodiments, similar to data generated by sensor(s) 230, data generated by sensors onboard other vehicle(s) 250 may be correlated or fused with sensor data generated by LiDAR system(s) 210 (or with other LiDAR systems located in other vehicles), thereby at least partially offloading the sensor fusion process performed by vehicle perception and planning system 220.

In some embodiments, intelligent infrastructure system(s) 240 are used to provide sensor data separately or together with LiDAR system(s) 210. Certain infrastructures may be configured to communicate with a vehicle to convey information and vice versa. Communications between a vehicle and infrastructures are generally referred to as V2I (vehicle to infrastructure) communications. For example, intelligent infrastructure system(s) 240 may include an intelligent traffic light that can convey its status to an approaching vehicle in a message such as “changing to yellow in 5 seconds.” Intelligent infrastructure system(s) 240 may also include its own LiDAR system mounted near an intersection such that it can convey traffic monitoring information to a vehicle. For example, a left-turning vehicle at an intersection may not have sufficient sensing capabilities because some of its own sensors may be blocked by traffic in the opposite direction. In such a situation, sensors of intelligent infrastructure system(s) 240 can provide useful data to the left-turning vehicle. Such data may include, for example, traffic conditions, information of objects in the direction the vehicle is turning to, traffic light status and predictions, or the like. These sensor data generated by intelligent infrastructure system(s) 240 can be provided to vehicle perception and planning system 220 and/or vehicle onboard LiDAR system(s) 210, via communication paths 243 and/or 241, respectively. Communication paths 243 and/or 241 can include any wired or wireless communication links that can transfer data. For example, sensor data from intelligent infrastructure system(s) 240 may be transmitted to LiDAR system(s) 210 and correlated or fused with sensor data generated by LiDAR system(s) 210, thereby at least partially offloading the sensor fusion process performed by vehicle perception and planning system 220. V2V and V2I communications described above are examples of vehicle-to-X (V2X) communications, where the “X” represents any other devices, systems, sensors, infrastructure, or the like that can share data with a vehicle.

With reference still to FIG. 2, via various communication paths, vehicle perception and planning system 220 receives sensor data from one or more of LiDAR system(s) 210, other vehicle onboard sensor(s) 230, other vehicle(s) 250, and/or intelligent infrastructure system(s) 240. In some embodiments, different types of sensor data are correlated and/or integrated by a sensor fusion sub-system 222. For example, sensor fusion sub-system 222 can generate a 360-degree model using multiple images or videos captured by multiple cameras disposed at different positions of the vehicle. Sensor fusion sub-system 222 obtains sensor data from different types of sensors and uses the combined data to perceive the environment more accurately. For example, a vehicle onboard camera 232 may not capture a clear image because it is facing the sun or a light source (e.g., another vehicle's headlight during nighttime) directly. A LiDAR system 210 may not be affected as much and therefore sensor fusion sub-system 222 can combine sensor data provided by both camera 232 and LiDAR system 210, and use the sensor data provided by LiDAR system 210 to compensate the unclear image captured by camera 232. As another example, in a rainy or foggy weather, a radar sensor 234 may work better than a camera 232 or a LiDAR system 210. Accordingly, sensor fusion sub-system 222 may use sensor data provided by the radar sensor 234 to compensate the sensor data provided by camera 232 or LiDAR system 210.

In other examples, sensor data generated by other vehicle onboard sensor(s) 230 may have a lower resolution (e.g., radar sensor data) and thus may need to be correlated and confirmed by LiDAR system(s) 210, which usually has a higher resolution. For example, a sewage cover (also referred to as a manhole cover) may be detected by radar sensor 234 as an object towards which a vehicle is approaching. Due to the low-resolution nature of radar sensor 234, vehicle perception and planning system 220 may not be able to determine whether the object is an obstacle that the vehicle needs to avoid. High-resolution sensor data generated by LiDAR system(s) 210 thus can be used to correlated and confirm that the object is a sewage cover and causes no harm to the vehicle.

Vehicle perception and planning system 220 further comprises an object classifier 223. Using raw sensor data and/or correlated/fused data provided by sensor fusion sub-system 222, object classifier 223 can use any computer vision techniques to detect and classify the objects and estimate the positions of the objects. In some embodiments, object classifier 223 can use machine-learning based techniques to detect and classify objects. Examples of the machine-learning based techniques include utilizing algorithms such as region-based convolutional neural networks (R-CNN), Fast R-CNN, Faster R-CNN, histogram of oriented gradients (HOG), region-based fully convolutional network (R-FCN), single shot detector (SSD), spatial pyramid pooling (SPP-net), and/or You Only Look Once (Yolo).

Vehicle perception and planning system 220 further comprises a road detection sub-system 224. Road detection sub-system 224 localizes the road and identifies objects and/or markings on the road. For example, based on raw or fused sensor data provided by radar sensor(s) 234, camera(s) 232, and/or LiDAR system(s) 210, road detection sub-system 224 can build a 3D model of the road based on machine-learning techniques (e.g., pattern recognition algorithms for identifying lanes). Using the 3D model of the road, road detection sub-system 224 can identify objects (e.g., obstacles or debris on the road) and/or markings on the road (e.g., lane lines, turning marks, crosswalk marks, or the like).

Vehicle perception and planning system 220 further comprises a localization and vehicle posture sub-system 225. Based on raw or fused sensor data, localization and vehicle posture sub-system 225 can determine position of the vehicle and the vehicle's posture. For example, using sensor data from LiDAR system(s) 210, camera(s) 232, and/or GPS data, localization and vehicle posture sub-system 225 can determine an accurate position of the vehicle on the road and the vehicle's six degrees of freedom (e.g., whether the vehicle is moving forward or backward, up or down, and left or right). In some embodiments, high-definition (HD) maps are used for vehicle localization. HD maps can provide highly detailed, three-dimensional, computerized maps that pinpoint a vehicle's location. For instance, using the HD maps, localization and vehicle posture sub-system 225 can determine precisely the vehicle's current position (e.g., which lane of the road the vehicle is currently in, how close it is to a curb or a sidewalk) and predict vehicle's future positions.

Vehicle perception and planning system 220 further comprises obstacle predictor 226. Objects identified by object classifier 223 can be stationary (e.g., a light pole, a road sign) or dynamic (e.g., a moving pedestrian, bicycle, another car). For moving objects, predicting their moving path or future positions can be important to avoid collision. Obstacle predictor 226 can predict an obstacle trajectory and/or warn the driver or the vehicle planning sub-system 228 about a potential collision. For example, if there is a high likelihood that the obstacle's trajectory intersects with the vehicle's current moving path, obstacle predictor 226 can generate such a warning. Obstacle predictor 226 can use a variety of techniques for making such a prediction. Such techniques include, for example, constant velocity or acceleration models, constant turn rate and velocity/acceleration models, Kalman Filter and Extended Kalman Filter based models, recurrent neural network (RNN) based models, long short-term memory (LSTM) neural network based models, encoder-decoder RNN models, or the like.

With reference still to FIG. 2, in some embodiments, vehicle perception and planning system 220 further comprises vehicle planning sub-system 228. Vehicle planning sub-system 228 can include one or more planners such as a route planner, a driving behaviors planner, and a motion planner. The route planner can plan the route of a vehicle based on the vehicle's current location data, target location data, traffic information, etc. The driving behavior planner adjusts the timing and planned movement based on how other objects might move, using the obstacle prediction results provided by obstacle predictor 226. The motion planner determines the specific operations the vehicle needs to follow. The planning results are then communicated to vehicle control system 280 via vehicle interface 270. The communication can be performed through communication paths 223 and 271, which include any wired or wireless communication links that can transfer data.

Vehicle control system 280 controls the vehicle's steering mechanism, throttle, brake, etc., to operate the vehicle according to the planned route and movement. In some examples, vehicle perception and planning system 220 may further comprise a user interface 260, which provides a user (e.g., a driver) access to vehicle control system 280 to, for example, override or take over control of the vehicle when necessary. User interface 260 may also be separate from vehicle perception and planning system 220. User interface 260 can communicate with vehicle perception and planning system 220, for example, to obtain and display raw or fused sensor data, identified objects, vehicle's location/posture, etc. These displayed data can help a user to better operate the vehicle. User interface 260 can communicate with vehicle perception and planning system 220 and/or vehicle control system 280 via communication paths 221 and 261 respectively, which include any wired or wireless communication links that can transfer data. It is understood that the various systems, sensors, communication links, and interfaces in FIG. 2 can be configured in any desired manner and not limited to the configuration shown in FIG. 2.

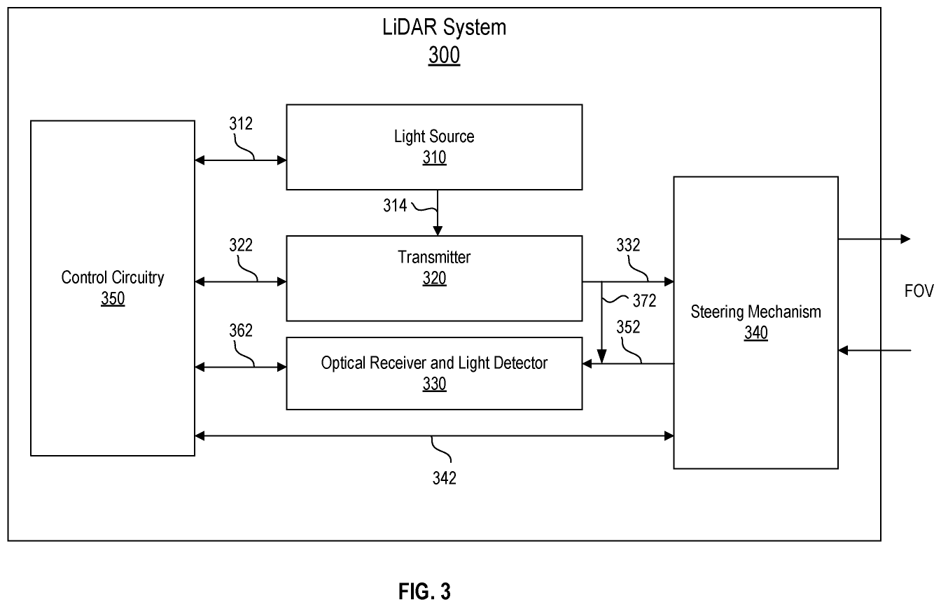

FIG. 3 is a block diagram illustrating an example LiDAR system 300. LiDAR system 300 can be used to implement LiDAR systems 110, 120A-120I, and/or 210 shown in FIGS. 1 and 2. In one embodiment, LiDAR system 300 comprises a light source 310, a transmitter 320, an optical receiver and light detector 330, a steering system 340, and a control circuitry 350. These components are coupled together using communications paths 312, 314, 322, 332, 342, 352, and 362. These communications paths include communication links (wired or wireless, bidirectional or unidirectional) among the various LiDAR system components, but need not be physical components themselves. While the communications paths can be implemented by one or more electrical wires, buses, or optical fibers, the communication paths can also be wireless channels or free-space optical paths so that no physical communication medium is present. For example, in one embodiment of LiDAR system 300, communication path 314 between light source 310 and transmitter 320 may be implemented using one or more optical fibers. Communication paths 332 and 352 may represent optical paths implemented using free space optical components and/or optical fibers. And communication paths 312, 322, 342, and 362 may be implemented using one or more electrical wires that carry electrical signals. The communications paths can also include one or more of the above types of communication mediums (e.g., they can include an optical fiber and a free-space optical component, or include one or more optical fibers and one or more electrical wires).

In some embodiments, LiDAR system 300 can be a coherent LiDAR system. One example is a frequency-modulated continuous-wave (FMCW) LiDAR. Coherent LiDARs detect objects by mixing return light from the objects with light from the coherent laser transmitter. Thus, as shown in FIG. 3, if LiDAR system 300 is a coherent LiDAR, it may include a route 372 providing a portion of transmission light from transmitter 320 to optical receiver and light detector 330. The transmission light provided by transmitter 320 may be modulated light and can be split into two portions. One portion is transmitted to the FOV, while the second portion is sent to the optical receiver and light detector of the LiDAR system. The second portion is also referred to as the light that is kept local (LO) to the LiDAR system. The transmission light is scattered or reflected by various objects in the FOV and at least a portion of it forms return light. The return light is subsequently detected and interferometrically recombined with the second portion of the transmission light that was kept local. Coherent LiDAR provides a means of optically sensing an object's range as well as its relative velocity along the line-of-sight (LOS).

LiDAR system 300 can also include other components not depicted in FIG. 3, such as power buses, power supplies, LED indicators, switches, etc. Additionally, other communication connections among components may be present, such as a direct connection between light source 310 and optical receiver and light detector 330 to provide a reference signal so that the time from when a light pulse is transmitted until a return light pulse is detected can be accurately measured.

Light source 310 outputs laser light for illuminating objects in a field of view (FOV). The laser light can be infrared light having a wavelength in the range of 700 nm to 1 mm. Light source 310 can be, for example, a semiconductor-based laser (e.g., a diode laser) and/or a fiber-based laser. A semiconductor-based laser can be, for example, an edge emitting laser (EEL), a vertical cavity surface emitting laser (VCSEL), an external-cavity diode laser, a vertical-external-cavity surface-emitting laser, a distributed feedback (DFB) laser, a distributed Bragg reflector (DBR) laser, an interband cascade laser, a quantum cascade laser, a quantum well laser, a double heterostructure laser, or the like. A fiber-based laser is a laser in which the active gain medium is an optical fiber doped with rare-earth elements such as erbium, ytterbium, neodymium, dysprosium, praseodymium, thulium and/or holmium. In some embodiments, a fiber laser is based on double-clad fibers, in which the gain medium forms the core of the fiber surrounded by two layers of cladding. The double-clad fiber allows the core to be pumped with a high-power beam, thereby enabling the laser source to be a high power fiber laser source.

In some embodiments, light source 310 comprises a master oscillator (also referred to as a seed laser) and power amplifier (MOPA). The power amplifier amplifies the output power of the seed laser. The power amplifier can be a fiber amplifier, a bulk amplifier, or a semiconductor optical amplifier. The seed laser can be a diode laser (e.g., a Fabry-Perot cavity laser, a distributed feedback laser), a solid-state bulk laser, or a tunable external-cavity diode laser. In some embodiments, light source 310 can be an optically pumped microchip laser. Microchip lasers are alignment-free monolithic solid-state lasers where the laser crystal is directly contacted with the end mirrors of the laser resonator. A microchip laser is typically pumped with a laser diode (directly or using a fiber) to obtain the desired output power. A microchip laser can be based on neodymium-doped yttrium aluminum garnet (Y₃Al₅O₁₂) laser crystals (i.e., Nd:YAG), or neodymium-doped vanadate (i.e., ND:YVO4) laser crystals. In some examples, light source 310 may have multiple amplification stages to achieve a high power gain such that the laser output can have high power, thereby enabling the LiDAR system to have a long scanning range. In some examples, the power amplifier of light source 310 can be controlled such that the power gain can be varied to achieve any desired laser output power.

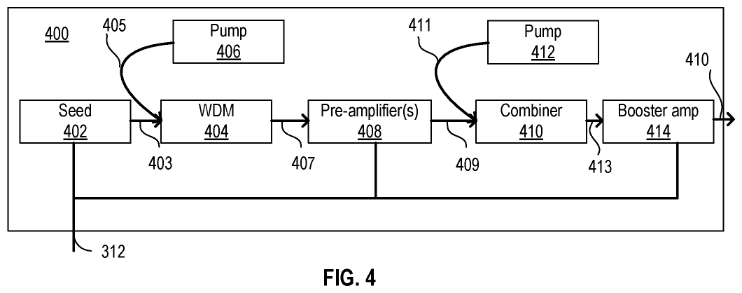

FIG. 4 is a block diagram illustrating an example fiber-based laser source 400 having a seed laser and one or more pumps (e.g., laser diodes) for pumping desired output power. Fiber-based laser source 400 is an example of light source 310 depicted in FIG. 3. In some embodiments, fiber-based laser source 400 comprises a seed laser 402 to generate initial light pulses of one or more wavelengths (e.g., infrared wavelengths such as 1550 nm), which are provided to a wavelength-division multiplexor (WDM) 404 via an optical fiber 403. Fiber-based laser source 400 further comprises a pump 406 for providing laser power (e.g., of a different wavelength, such as 980 nm) to WDM 404 via an optical fiber 405. WDM 404 multiplexes the light pulses provided by seed laser 402 and the laser power provided by pump 406 onto a single optical fiber 407. The output of WDM 404 can then be provided to one or more pre-amplifier(s) 408 via optical fiber 407. Pre-amplifier(s) 408 can be optical amplifier(s) that amplify optical signals (e.g., with about 10-30 dB gain). In some embodiments, pre-amplifier(s) 408 are low noise amplifiers. Pre-amplifier(s) 408 output to an optical combiner 410 via an optical fiber 409. Combiner 410 combines the output laser light of pre-amplifier(s) 408 with the laser power provided by pump 412 via an optical fiber 411. Combiner 410 can combine optical signals having the same wavelength or different wavelengths. One example of a combiner is a WDM. Combiner 410 provides combined optical signals to a booster amplifier 414, which produces output light pulses via optical fiber 410. The booster amplifier 414 provides further amplification of the optical signals (e.g., another 20-40 dB). The outputted light pulses can then be transmitted to transmitter 320 and/or steering mechanism 340 (shown in FIG. 3). It is understood that FIG. 4 illustrates one example configuration of fiber-based laser source 400. Laser source 400 can have many other configurations using different combinations of one or more components shown in FIG. 4 and/or other components not shown in FIG. 4 (e.g., other components such as power supplies, lens(es), filters, splitters, combiners, etc.).

In some variations, fiber-based laser source 400 can be controlled (e.g., by control circuitry 350) to produce pulses of different amplitudes based on the fiber gain profile of the fiber used in fiber-based laser source 400. Communication path 312 couples fiber-based laser source 400 to control circuitry 350 (shown in FIG. 3) so that components of fiber-based laser source 400 can be controlled by or otherwise communicate with control circuitry 350. Alternatively, fiber-based laser source 400 may include its own dedicated controller. Instead of control circuitry 350 communicating directly with components of fiber-based laser source 400, a dedicated controller of fiber-based laser source 400 communicates with control circuitry 350 and controls and/or communicates with the components of fiber-based laser source 400. Fiber-based laser source 400 can also include other components not shown, such as one or more power connectors, power supplies, and/or power lines.

Referencing FIG. 3, typical operating wavelengths of light source 310 comprise, for example, about 850 nm, about 905 nm, about 940 nm, about 1064 nm, and about 1550 nm. For laser safety, the upper limit of maximum usable laser power is set by the U.S. FDA (U.S. Food and Drug Administration) regulations. The optical power limit at 1550 nm wavelength is much higher than those of the other aforementioned wavelengths. Further, at 1550 nm, the optical power loss in a fiber is low. There characteristics of the 1550 nm wavelength make it more beneficial for long-range LiDAR applications. The amount of optical power output from light source 310 can be characterized by its peak power, average power, pulse energy, and/or the pulse energy density. The peak power is the ratio of pulse energy to the width of the pulse (e.g., full width at half maximum or FWHM). Thus, a smaller pulse width can provide a larger peak power for a fixed amount of pulse energy. A pulse width can be in the range of nanosecond or picosecond. The average power is the product of the energy of the pulse and the pulse repetition rate (PRR). As described in more detail below, the PRR represents the frequency of the pulsed laser light. In general, the smaller the time interval between the pulses, the higher the PRR. The PRR typically corresponds to the maximum range that a LiDAR system can measure. Light source 310 can be configured to produce pulses at high PRR to meet the desired number of data points in a point cloud generated by the LiDAR system. Light source 310 can also be configured to produce pulses at medium or low PRR to meet the desired maximum detection distance. Wall plug efficiency (WPE) is another factor to evaluate the total power consumption, which may be a useful indicator in evaluating the laser efficiency. For example, as shown in FIG. 1, multiple LiDAR systems may be attached to a vehicle, which may be an electrical-powered vehicle or a vehicle otherwise having limited fuel or battery power supply. Therefore, high WPE and intelligent ways to use laser power are often among the important considerations when selecting and configuring light source 310 and/or designing laser delivery systems for vehicle-mounted LiDAR applications.

It is understood that the above descriptions provide non-limiting examples of a light source 310. Light source 310 can be configured to include many other types of light sources (e.g., laser diodes, short-cavity fiber lasers, solid-state lasers, and/or tunable external cavity diode lasers) that are configured to generate one or more light signals at various wavelengths. In some examples, light source 310 comprises amplifiers (e.g., pre-amplifiers and/or booster amplifiers), which can be a doped optical fiber amplifier, a solid-state bulk amplifier, and/or a semiconductor optical amplifier. The amplifiers are configured to receive and amplify light signals with desired gains.

With reference back to FIG. 3, LiDAR system 300 further comprises a transmitter 320. Light source 310 provides laser light (e.g., in the form of a laser beam) to transmitter 320. The laser light provided by light source 310 can be amplified laser light with a predetermined or controlled wavelength, pulse repetition rate, and/or power level. Transmitter 320 receives the laser light from light source 310 and transmits the laser light to steering mechanism 340 with low divergence. In some embodiments, transmitter 320 can include, for example, optical components (e.g., lens, fibers, mirrors, etc.) for transmitting one or more laser beams to a field-of-view (FOV) directly or via steering mechanism 340. While FIG. 3 illustrates transmitter 320 and steering mechanism 340 as separate components, they may be combined or integrated as one system in some embodiments. Steering mechanism 340 is described in more detail below.

Laser beams provided by light source 310 may diverge as they travel to transmitter 320. Therefore, transmitter 320 often comprises a collimating lens configured to collect the diverging laser beams and produce more parallel optical beams with reduced or minimum divergence. The collimated optical beams can then be further directed through various optics such as mirrors and lens. A collimating lens may be, for example, a single plano-convex lens or a lens group. The collimating lens can be configured to achieve any desired properties such as the beam diameter, divergence, numerical aperture, focal length, or the like. A beam propagation ratio or beam quality factor (also referred to as the M² factor) is used for measurement of laser beam quality. In many LiDAR applications, it is important to have good laser beam quality in the generated transmitting laser beam. The M² factor represents a degree of variation of a beam from an ideal Gaussian beam. Thus, the M² factor reflects how well a collimated laser beam can be focused on a small spot, or how well a divergent laser beam can be collimated. Therefore, light source 310 and/or transmitter 320 can be configured to meet, for example, a scan resolution requirement while maintaining the desired M² factor.

One or more of the light beams provided by transmitter 320 are scanned by steering mechanism 340 to a FOV. Steering mechanism 340 scans light beams in multiple dimensions (e.g., in both the horizontal and vertical dimension) to facilitate LiDAR system 300 to map the environment by generating a 3D point cloud. A horizontal dimension can be a dimension that is parallel to the horizon or a surface associated with the LiDAR system or a vehicle (e.g., a road surface). A vertical dimension is perpendicular to the horizontal dimension (i.e., the vertical dimension forms a 90-degree angle with the horizontal dimension). Steering mechanism 340 will be described in more detail below. The laser light scanned to an FOV may be scattered or reflected by an object in the FOV. At least a portion of the scattered or reflected light forms return light that returns to LiDAR system 300. FIG. 3 further illustrates an optical receiver and light detector 330 configured to receive the return light. Optical receiver and light detector 330 comprises an optical receiver that is configured to collect the return light from the FOV. The optical receiver can include optics (e.g., lens, fibers, mirrors, etc.) for receiving, redirecting, focusing, amplifying, and/or filtering return light from the FOV. For example, the optical receiver often includes a collection lens (e.g., a single plano-convex lens or a lens group) to collect and/or focus the collected return light onto a light detector.

A light detector detects the return light focused by the optical receiver and generates current and/or voltage signals proportional to the incident intensity of the return light. Based on such current and/or voltage signals, the depth information of the object in the FOV can be derived. One example method for deriving such depth information is based on the direct TOF (time of flight), which is described in more detail below. A light detector may be characterized by its detection sensitivity, quantum efficiency, detector bandwidth, linearity, signal to noise ratio (SNR), overload resistance, interference immunity, etc. Based on the applications, the light detector can be configured or customized to have any desired characteristics. For example, optical receiver and light detector 330 can be configured such that the light detector has a large dynamic range while having a good linearity. The light detector linearity indicates the detector's capability of maintaining linear relationship between input optical signal power and the detector's output. A detector having good linearity can maintain a linear relationship over a large dynamic input optical signal range.

To achieve desired detector characteristics, configurations or customizations can be made to the light detector's structure and/or the detector's material system. Various detector structure can be used for a light detector. For example, a light detector structure can be a PIN based structure, which has a undoped intrinsic semiconductor region (i.e., an “i” region) between a p-type semiconductor and an n-type semiconductor region. Other light detector structures comprise, for example, an APD (avalanche photodiode) based structure, a PMT (photomultiplier tube) based structure, a SiPM (Silicon photomultiplier) based structure, a SPAD (single-photon avalanche diode) based structure, and/or quantum wires. For material systems used in a light detector, Si, InGaAs, and/or Si/Ge based materials can be used. It is understood that many other detector structures and/or material systems can be used in optical receiver and light detector 330.

A light detector (e.g., an APD based detector) may have an internal gain such that the input signal is amplified when generating an output signal. However, noise may also be amplified due to the light detector's internal gain. Common types of noise include signal shot noise, dark current shot noise, thermal noise, and amplifier noise. In some embodiments, optical receiver and light detector 330 may include a pre-amplifier that is a low noise amplifier (LNA). In some embodiments, the pre-amplifier may also include a transimpedance amplifier (TIA), which converts a current signal to a voltage signal. For a linear detector system, input equivalent noise or noise equivalent power (NEP) measures how sensitive the light detector is to weak signals. Therefore, they can be used as indicators of the overall system performance. For example, the NEP of a light detector specifies the power of the weakest signal that can be detected and therefore it in turn specifies the maximum range of a LiDAR system. It is understood that various light detector optimization techniques can be used to meet the requirement of LiDAR system 300. Such optimization techniques may include selecting different detector structures, materials, and/or implementing signal processing techniques (e.g., filtering, noise reduction, amplification, or the like). For example, in addition to, or instead of, using direct detection of return signals (e.g., by using ToF), coherent detection can also be used for a light detector. Coherent detection allows for detecting amplitude and phase information of the received light by interfering the received light with a local oscillator. Coherent detection can improve detection sensitivity and noise immunity.

FIG. 3 further illustrates that LiDAR system 300 comprises steering mechanism 340. As described above, steering mechanism 340 directs light beams from transmitter 320 to scan an FOV in multiple dimensions. A steering mechanism is referred to as a raster mechanism, a scanning mechanism, or simply a light scanner. Scanning light beams in multiple directions (e.g., in both the horizontal and vertical directions) facilitates a LiDAR system to map the environment by generating an image or a 3D point cloud. A steering mechanism can be based on mechanical scanning and/or solid-state scanning. Mechanical scanning uses rotating mirrors to steer the laser beam or physically rotate the LiDAR transmitter and receiver (collectively referred to as transceiver) to scan the laser beam. Solid-state scanning directs the laser beam to various positions through the FOV without mechanically moving any macroscopic components such as the transceiver. Solid-state scanning mechanisms include, for example, optical phased arrays based steering and flash LiDAR based steering. In some embodiments, because solid-state scanning mechanisms do not physically move macroscopic components, the steering performed by a solid-state scanning mechanism may be referred to as effective steering. A LiDAR system using solid-state scanning may also be referred to as a non-mechanical scanning or simply non-scanning LiDAR system (a flash LiDAR system is an example non-scanning LiDAR system).

Steering mechanism 340 can be used with a transceiver (e.g., transmitter 320 and optical receiver and light detector 330) to scan the FOV for generating an image or a 3D point cloud. As an example, to implement steering mechanism 340, a two-dimensional mechanical scanner can be used with a single-point or several single-point transceivers. A single-point transceiver transmits a single light beam or a small number of light beams (e.g., 2-8 beams) to the steering mechanism. A two-dimensional mechanical steering mechanism comprises, for example, polygon mirror(s), oscillating mirror(s), rotating prism(s), rotating tilt mirror surface(s), single-plane or multi-plane mirror(s), or a combination thereof. In some embodiments, steering mechanism 340 may include non-mechanical steering mechanism(s) such as solid-state steering mechanism(s). For example, steering mechanism 340 can be based on tuning wavelength of the laser light combined with refraction effect, and/or based on reconfigurable grating/phase array. In some embodiments, steering mechanism 340 can use a single scanning device to achieve two-dimensional scanning or multiple scanning devices combined to realize two-dimensional scanning.

As another example, to implement steering mechanism 340, a one-dimensional mechanical scanner can be used with an array or a large number of single-point transceivers. Specifically, the transceiver array can be mounted on a rotating platform to achieve 360-degree horizontal field of view. Alternatively, a static transceiver array can be combined with the one-dimensional mechanical scanner. A one-dimensional mechanical scanner comprises polygon mirror(s), oscillating mirror(s), rotating prism(s), rotating tilt mirror surface(s), or a combination thereof, for obtaining a forward-looking horizontal field of view. Steering mechanisms using mechanical scanners can provide robustness and reliability in high volume production for automotive applications.

As another example, to implement steering mechanism 340, a two-dimensional transceiver can be used to generate a scan image or a 3D point cloud directly. In some embodiments, a stitching or micro shift method can be used to improve the resolution of the scan image or the field of view being scanned. For example, using a two-dimensional transceiver, signals generated at one direction (e.g., the horizontal direction) and signals generated at the other direction (e.g., the vertical direction) may be integrated, interleaved, and/or matched to generate a higher or full resolution image or 3D point cloud representing the scanned FOV.

Some implementations of steering mechanism 340 comprise one or more optical redirection elements (e.g., mirrors or lenses) that steer return light signals (e.g., by rotating, vibrating, or directing) along a receive path to direct the return light signals to optical receiver and light detector 330. The optical redirection elements that direct light signals along the transmitting and receiving paths may be the same components (e.g., shared), separate components (e.g., dedicated), and/or a combination of shared and separate components. This means that in some cases the transmitting and receiving paths are different although they may partially overlap (or in some cases, substantially overlap or completely overlap).

With reference still to FIG. 3, LiDAR system 300 further comprises control circuitry 350. Control circuitry 350 can be configured and/or programmed to control various parts of the LiDAR system 300 and/or to perform signal processing. In a typical system, control circuitry 350 can be configured and/or programmed to perform one or more control operations including, for example, controlling light source 310 to obtain the desired laser pulse timing, the pulse repetition rate, and power; controlling steering mechanism 340 (e.g., controlling the speed, direction, and/or other parameters) to scan the FOV and maintain pixel registration and/or alignment; controlling optical receiver and light detector 330 (e.g., controlling the sensitivity, noise reduction, filtering, and/or other parameters) such that it is an optimal state; and monitoring overall system health/status for functional safety (e.g., monitoring the laser output power and/or the steering mechanism operating status for safety).

Control circuitry 350 can also be configured and/or programmed to perform signal processing to the raw data generated by optical receiver and light detector 330 to derive distance and reflectance information, and perform data packaging and communication to vehicle perception and planning system 220 (shown in FIG. 2). For example, control circuitry 350 determines the time it takes from transmitting a light pulse until a corresponding return light pulse is received; determines when a return light pulse is not received for a transmitted light pulse; determines the direction (e.g., horizontal and/or vertical information) for a transmitted/return light pulse; determines the estimated range in a particular direction; derives the reflectivity of an object in the FOV, and/or determines any other type of data relevant to LiDAR system 300.

LiDAR system 300 can be disposed in a vehicle, which may operate in many different environments including hot or cold weather, rough road conditions that may cause intense vibration, high or low humidities, dusty areas, etc. Therefore, in some embodiments, optical and/or electronic components of LiDAR system 300 (e.g., optics in transmitter 320, optical receiver and light detector 330, and steering mechanism 340) are disposed and/or configured in such a manner to maintain long term mechanical and optical stability. For example, components in LiDAR system 300 may be secured and sealed such that they can operate under all conditions a vehicle may encounter. As an example, an anti-moisture coating and/or hermetic sealing may be applied to optical components of transmitter 320, optical receiver and light detector 330, and steering mechanism 340 (and other components that are susceptible to moisture). As another example, housing(s), enclosure(s), fairing(s), and/or window can be used in LiDAR system 300 for providing desired characteristics such as hardness, ingress protection (IP) rating, self-cleaning capability, resistance to chemical and resistance to impact, or the like. In addition, efficient and economical methodologies for assembling LiDAR system 300 may be used to meet the LiDAR operating requirements while keeping the cost low.

It is understood by a person of ordinary skill in the art that FIG. 3 and the above descriptions are for illustrative purposes only, and a LiDAR system can include other functional units, blocks, or segments, and can include variations or combinations of these above functional units, blocks, or segments. For example, LiDAR system 300 can also include other components not depicted in FIG. 3, such as power buses, power supplies, LED indicators, switches, etc. Additionally, other connections among components may be present, such as a direct connection between light source 310 and optical receiver and light detector 330 so that light detector 330 can accurately measure the time from when light source 310 transmits a light pulse until light detector 330 detects a return light pulse.

These components shown in FIG. 3 are coupled together using communications paths 312, 314, 322, 332, 342, 352, and 362. These communications paths represent communication (bidirectional or unidirectional) among the various LiDAR system components but need not be physical components themselves. While the communications paths can be implemented by one or more electrical wires, busses, or optical fibers, the communication paths can also be wireless channels or open-air optical paths so that no physical communication medium is present. For example, in one example LiDAR system, communication path 314 includes one or more optical fibers; communication path 352 represents an optical path; and communication paths 312, 322, 342, and 362 are all electrical wires that carry electrical signals. The communication paths can also include more than one of the above types of communication mediums (e.g., they can include an optical fiber and an optical path, or one or more optical fibers and one or more electrical wires).

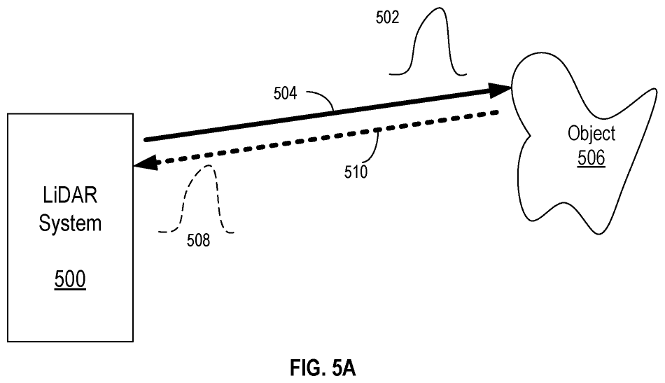

As described above, some LiDAR systems use the time-of-flight (ToF) of light signals (e.g., light pulses) to determine the distance to objects in a light path. For example, with reference to FIG. 5A, an example LiDAR system 500 includes a laser light source (e.g., a fiber laser), a steering mechanism (e.g., a system of one or more moving mirrors), and a light detector (e.g., a photodetector with one or more optics). LiDAR system 500 can be implemented using, for example, LiDAR system 300 described above. LiDAR system 500 transmits a light pulse 502 along light path 504 as determined by the steering mechanism of LiDAR system 500. In the depicted example, light pulse 502, which is generated by the laser light source, is a short pulse of laser light. Further, the signal steering mechanism of the LiDAR system 500 is a pulsed-signal steering mechanism. However, it should be appreciated that LiDAR systems can operate by generating, transmitting, and detecting light signals that are not pulsed and derive ranges to an object in the surrounding environment using techniques other than time-of-flight. For example, some LiDAR systems use frequency modulated continuous waves (i.e., “FMCW”). It should be further appreciated that any of the techniques described herein with respect to time-of-flight based systems that use pulsed signals also may be applicable to LiDAR systems that do not use one or both of these techniques.

Referring back to FIG. 5A (e.g., illustrating a time-of-flight LiDAR system that uses light pulses), when light pulse 502 reaches object 506, light pulse 502 scatters or reflects to form a return light pulse 508. Return light pulse 508 may return to system 500 along light path 510. The time from when transmitted light pulse 502 leaves LiDAR system 500 to when return light pulse 508 arrives back at LiDAR system 500 can be measured (e.g., by a processor or other electronics, such as control circuitry 350, within the LiDAR system). This time-of-flight combined with the knowledge of the speed of light can be used to determine the range/distance from LiDAR system 500 to the portion of object 506 where light pulse 502 scattered or reflected.

By directing many light pulses, as depicted in FIG. 5B, LiDAR system 500 scans the external environment (e.g., by directing light pulses 502, 522, 526, 530 along light paths 504, 524, 528, 532, respectively). As depicted in FIG. 5C, LiDAR system 500 receives return light pulses 508, 542, 548 (which correspond to transmitted light pulses 502, 522, 530, respectively). Return light pulses 508, 542, and 548 are formed by scattering or reflecting the transmitted light pulses by one of objects 506 and 514. Return light pulses 508, 542, and 548 may return to LiDAR system 500 along light paths 510, 544, and 546, respectively. Based on the direction of the transmitted light pulses (as determined by LiDAR system 500) as well as the calculated range from LiDAR system 500 to the portion of objects that scatter or reflect the light pulses (e.g., the portions of objects 506 and 514), the external environment within the detectable range (e.g., the field of view between path 504 and 532, inclusively) can be precisely mapped or plotted (e.g., by generating a 3D point cloud or images).

If a corresponding light pulse is not received for a particular transmitted light pulse, then LiDAR system 500 may determine that there are no objects within a detectable range of LiDAR system 500 (e.g., an object is beyond the maximum scanning distance of LiDAR system 500). For example, in FIG. 5B, light pulse 526 may not have a corresponding return light pulse (as illustrated in FIG. 5C) because light pulse 526 may not produce a scattering event along its transmission path 528 within the predetermined detection range. LiDAR system 500, or an external system in communication with LiDAR system 500 (e.g., a cloud system or service), can interpret the lack of return light pulse as no object being disposed along light path 528 within the detectable range of LiDAR system 500.

In FIG. 5B, light pulses 502, 522, 526, and 530 can be transmitted in any order, serially, in parallel, or based on other timings with respect to each other. Additionally, while FIG. 5B depicts transmitted light pulses as being directed in one dimension or one plane (e.g., the plane of the paper), LiDAR system 500 can also direct transmitted light pulses along other dimension(s) or plane(s). For example, LiDAR system 500 can also direct transmitted light pulses in a dimension or plane that is perpendicular to the dimension or plane shown in FIG. 5B, thereby forming a 2-dimensional transmission of the light pulses. This 2-dimensional transmission of the light pulses can be point-by-point, line-by-line, all at once, or in some other manner. That is, LiDAR system 500 can be configured to perform a point scan, a line scan, a one-shot without scanning, or a combination thereof. A point cloud or image from a 1-dimensional transmission of light pulses (e.g., a single horizontal line) can generate 2-dimensional data (e.g., (1) data from the horizontal transmission direction and (2) the range or distance to objects). Similarly, a point cloud or image from a 2-dimensional transmission of light pulses can generate 3-dimensional data (e.g., (1) data from the horizontal transmission direction, (2) data from the vertical transmission direction, and (3) the range or distance to objects). In general, a LiDAR system performing an n-dimensional transmission of light pulses generates (n+1) dimensional data. This is because the LiDAR system can measure the depth of an object or the range/distance to the object, which provides the extra dimension of data. Therefore, a 2D scanning by a LiDAR system can generate a 3D point cloud for mapping the external environment of the LiDAR system.

The density of a point cloud refers to the number of measurements (data points) per area performed by the LiDAR system. A point cloud density relates to the LiDAR scanning resolution. Typically, a larger point cloud density, and therefore a higher resolution, is desired at least for the region of interest (ROI). The density of points in a point cloud or image generated by a LiDAR system is equal to the number of pulses divided by the field of view. In some embodiments, the field of view can be fixed. Therefore, to increase the density of points generated by one set of transmission-receiving optics (or transceiver optics), the LiDAR system may need to generate a pulse more frequently. In other words, a light source in the LiDAR system may have a higher pulse repetition rate (PRR). On the other hand, by generating and transmitting pulses more frequently, the farthest distance that the LiDAR system can detect may be limited. For example, if a return signal from a distant object is received after the system transmits the next pulse, the return signals may be detected in a different order than the order in which the corresponding signals are transmitted, thereby causing ambiguity if the system cannot correctly correlate the return signals with the transmitted signals.

To illustrate, consider an example LiDAR system that can transmit laser pulses with a pulse repetition rate between 500 kHz and 1 MHz. Based on the time it takes for a pulse to return to the LiDAR system and to avoid mix-up of return pulses from consecutive pulses in a typical LiDAR design, the farthest distance the LiDAR system can detect may be 300 meters and 150 meters for 500 kHz and 1 MHz, respectively. The density of points of a LiDAR system with 500 kHz repetition rate is half of that with 1 MHz. Thus, this example demonstrates that, if the system cannot correctly correlate return signals that arrive out of order, increasing the repetition rate from 500 kHz to 1 MHz (and thus improving the density of points of the system) may reduce the detection range of the system. Various techniques are used to mitigate the tradeoff between higher PRR and limited detection range. For example, multiple wavelengths can be used for detecting objects in different ranges. Optical and/or signal processing techniques (e.g., pulse encoding techniques) are also used to correlate between transmitted and return light signals.

Various systems, apparatus, and methods described herein may be implemented using digital circuitry, or using one or more computers using well-known computer processors, memory units, storage devices, computer software, and other components. Typically, a computer includes a processor for executing instructions and one or more memories for storing instructions and data. A computer may also include, or be coupled to, one or more mass storage devices, such as one or more magnetic disks, internal hard disks and removable disks, magneto-optical disks, optical disks, etc.

Various systems, apparatus, and methods described herein may be implemented using computers operating in a client-server relationship. Typically, in such a system, the client computers are located remotely from the server computers and interact via a network. The client-server relationship may be defined and controlled by computer programs running on the respective client and server computers. Examples of client computers can include desktop computers, workstations, portable computers, cellular smartphones, tablets, or other types of computing devices.

Various systems, apparatus, and methods described herein may be implemented using a computer program product tangibly embodied in an information carrier, e.g., in a non-transitory machine-readable storage device, for execution by a programmable processor; and the method processes and steps described herein, may be implemented using one or more computer programs that are executable by such a processor. A computer program is a set of computer program instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

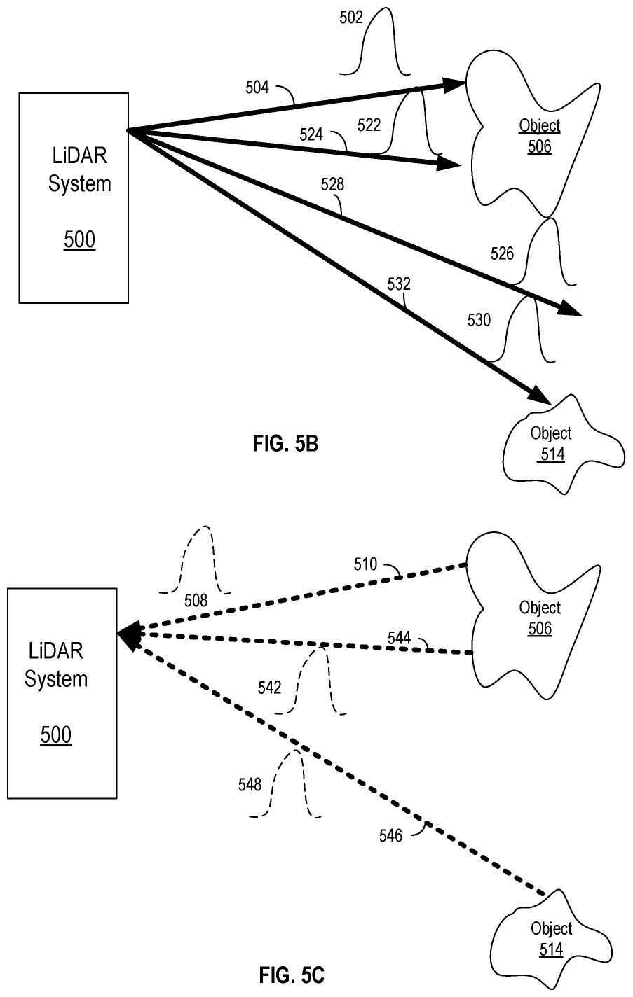

A high-level block diagram of an example apparatus that may be used to implement systems, apparatus and methods described herein is illustrated in FIG. 6. Apparatus 600 comprises a processor 610 operatively coupled to a persistent storage device 620 and a main memory device 630. Processor 610 controls the overall operation of apparatus 600 by executing computer program instructions that define such operations. The computer program instructions may be stored in persistent storage device 620, or other computer-readable medium, and loaded into main memory device 630 when execution of the computer program instructions is desired. For example, processor 610 may be used to implement one or more components and systems described herein, such as control circuitry 350 (shown in FIG. 3), vehicle perception and planning system 220 (shown in FIG. 2), and vehicle control system 280 (shown in FIG. 2). Thus, the method steps discussed herein can be defined by the computer program instructions stored in main memory device 630 and/or persistent storage device 620 and controlled by processor 610 executing the computer program instructions. For example, the computer program instructions can be implemented as computer executable code programmed by one skilled in the art to perform an algorithm defined by the method steps discussed herein. Accordingly, by executing the computer program instructions, the processor 610 executes an algorithm defined by the method steps discussed herein. Apparatus 600 also includes one or more network interfaces 680 for communicating with other devices via a network. Apparatus 600 may also include one or more input/output devices 690 that enable user interaction with apparatus 600 (e.g., display, keyboard, mouse, speakers, buttons, etc.).

Processor 610 may include both general and special purpose microprocessors and may be the sole processor or one of multiple processors of apparatus 600. Processor 610 may comprise one or more central processing units (CPUs), and one or more graphics processing units (GPUs), which, for example, may work separately from and/or multi-task with one or more CPUs to accelerate processing, e.g., for various image processing applications described herein. Processor 610, persistent storage device 620, and/or main memory device 630 may include, be supplemented by, or incorporated in, one or more application-specific integrated circuits (ASICs) and/or one or more field programmable gate arrays (FPGAs).

Persistent storage device 620 and main memory device 630 each comprise a tangible non-transitory computer readable storage medium. Persistent storage device 620, and main memory device 630, may each include high-speed random access memory, such as dynamic random access memory (DRAM), static random access memory (SRAM), double data rate synchronous dynamic random access memory (DDR RAM), or other random access solid state memory devices, and may include non-volatile memory, such as one or more magnetic disk storage devices such as internal hard disks and removable disks, magneto-optical disk storage devices, optical disk storage devices, flash memory devices, semiconductor memory devices, such as erasable programmable read-only memory (EPROM), electrically erasable programmable read-only memory (EEPROM), compact disc read-only memory (CD-ROM), digital versatile disc read-only memory (DVD-ROM) disks, or other non-volatile solid state storage devices.

Input/output devices 690 may include peripherals, such as a printer, scanner, display screen, etc. For example, input/output devices 690 may include a display device such as a cathode ray tube (CRT), plasma or liquid crystal display (LCD) monitor for displaying information to a user, a keyboard, and a pointing device such as a mouse or a trackball by which the user can provide input to apparatus 600.

Any or all of the functions of the systems and apparatuses discussed herein may be performed by processor 610, and/or incorporated in, an apparatus or a system such as LiDAR system 300. Further, LiDAR system 300 and/or apparatus 600 may utilize one or more neural networks or other deep-learning techniques performed by processor 610 or other systems or apparatuses discussed herein.

One skilled in the art will recognize that an implementation of an actual computer or computer system may have other structures and may contain other components as well, and that FIG. 6 is a high-level representation of some of the components of such a computer for illustrative purposes.

Microelectromechanical systems (MEMS) mirrors are utilized in LiDAR systems for laser beam steering. In comparison to steering mechanisms involving rotating mirrors and polygon structures, MEMS mirrors offer advantages such as reduced size and increased scanning speed. Furthermore, in MEMS devices, while the mirror plate moves to steer light, the remaining components of the MEMS device remain stationary. This enhances the reliability and stability of the MEMS devices.

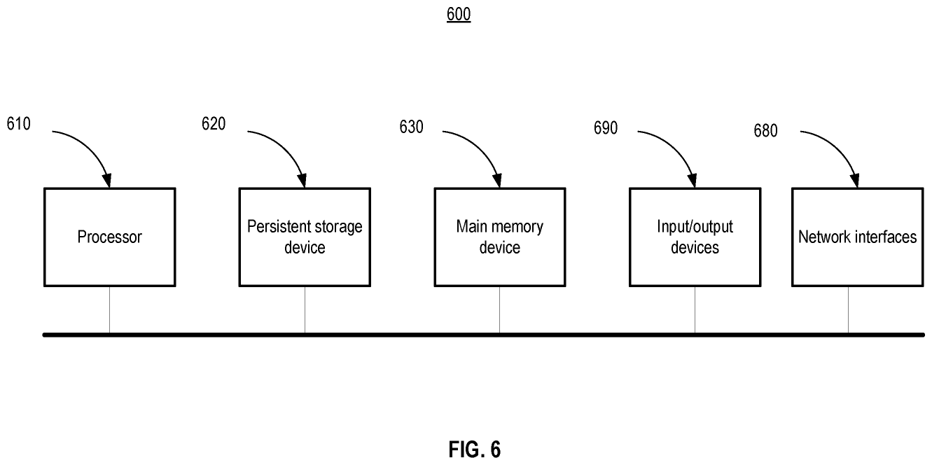

Electromagnetic MEMS mirrors operate based on the principle of Lorentz force. Lorentz force is the force experienced by a charged particle moving through a magnetic field. FIG. 7 illustrates Lorentz forces experienced by a current-carrying conductor in a magnetic field. “N” (711) depicts the north pole of a permanent magnet. “S” (712) depicts the south pole of a permanent magnet. “B” (730) depicts the magnetic field which flows from the north pole to the south pole. A conductor 720 is situated between the north and the south pole. When current “I” (721) flows through conductor 720 in the direction shown, Lorentz forces “F” (740) is applied to conductor 720. Lorentz force is the result of interaction of electric force exerted by electric field and magnetic force exerted by magnetic field on moving electrons in conductor 720. The direction of Lorentz force “F” follows Fleming's Left Hand Rule, as indicated in notation 701. According to Fleming's Left Hand Rule, using a left hand, if the index finger points to the direction of magnetic field “B”, and if the middle finger points to the direction of the current “I”, the thumb will point to the direction of the Lorentz force “F” acting on the conductor. Thus in FIG. 7, Lorentz forces “F” (740) applied on conductor 720 point in the upward direction based on the Left Hand Rule.

The magnitude of Lorentz force acting on the current-carrying conductor 720 can be obtained by the following formula (1):

|F|=|I·L·B·sin(θ)| (1)

In the above formula (1), “F” denotes the Lorentz force acting on the current-carrying conductor, “I” denotes the current flowing through the conductor, “L” denotes the length of the conductor segment in the magnetic field, “B” denotes the magnitude of the magnetic field, in tesla, and “θ” denotes the angle between the direction of the current and the direction of the magnetic field. Formula (1) indicates that the magnitude of Lorentz force applied to a current-carrying conductor is directly proportional to the magnitude of the current, and directly proportional to the magnitude of the magnetic field. This means that increasing either the current or the strength of the magnetic field will result in a larger Lorentz force acting on the conductor. Additionally, the angle between the direction of the current and the magnetic field affects the Lorentz force, as the force is greatest when the current and the magnetic field are perpendicular to each other (θ=90 degrees). When the current and the magnetic field are parallel (θ=0 or 180 degrees), the Lorentz force becomes zero, resulting in no Lorentz force acting on the conductor.

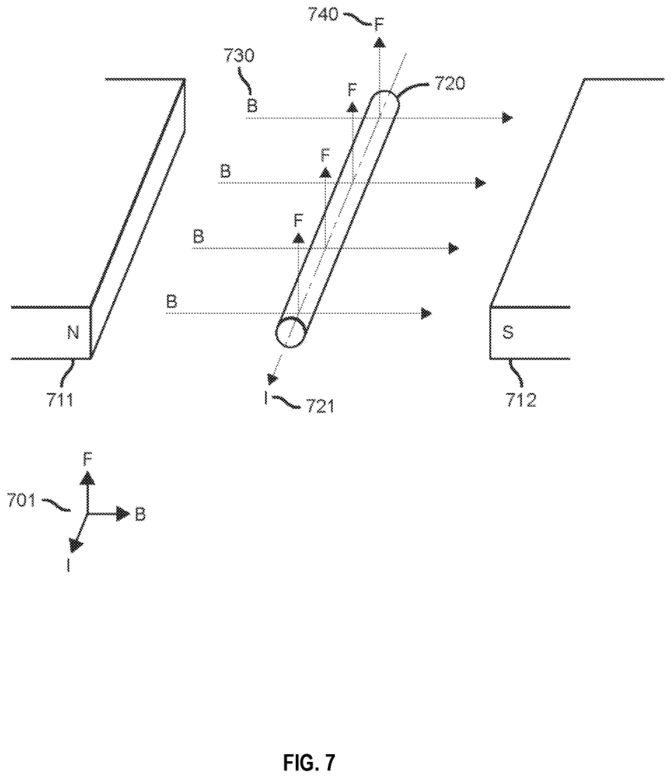

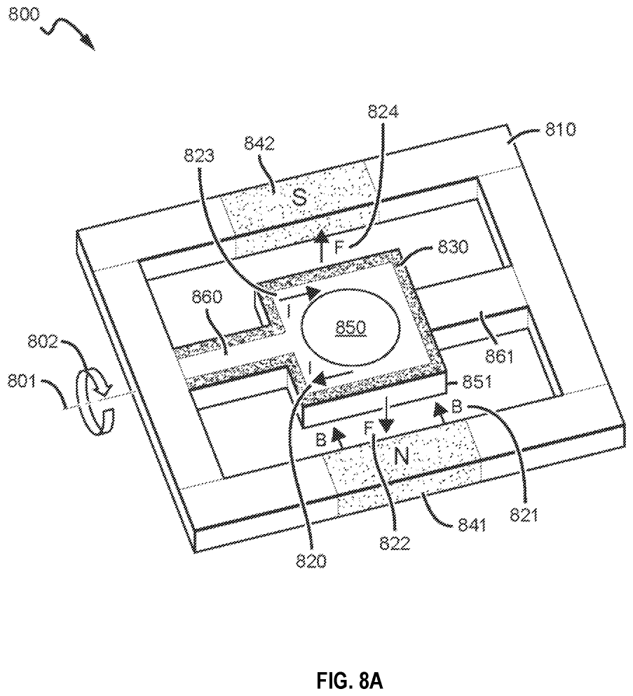

FIG. 8A illustrates an exemplary MEMS mirror apparatus 800 according to one embodiment. MEMS mirror apparatus 800 is a moveable scanner device, and can be used to implement at least a part of steering mechanism 340 shown in FIG. 3. For instance, instead of using macroscopic moveable mirrors such as polygon mirrors and galvanometer mirrors, MEMS mirror apparatus 800 can be used. In other examples, MEMS mirror apparatus 800 can be used to replace a portion of steering mechanism 340, such as the galvanometer mirrors. In one embodiment, MEMS mirror apparatus 800 includes a support frame 810, a first arm 860, a second arm 861, a MEMS mirror 850, and a platform 851. Support frame 810 can be made of metal, plastic, rubber, carbon fiber, or composite materials, etc. In some embodiments, support frame 810 includes one or more permanent magnets forming a north pole (841) and a south pole (842). In FIG. 8A, the one or more permanent magnets form a part of support frame 810. In some embodiments, the permanent magnets are partially or wholly independent of, or separate from, support frame 810. For instance, the permanent magnets may be physically attached to the support frame 810 but are not part of the support frame 810. In other examples, the permanent magnets may be physically detached from the support frame 810.

In one embodiment, MEMS mirror 850 is of a circular shape and is positioned at the center of platform 851, which is square-shaped. In other embodiments, MEMS mirror 850 may have an oval shape, a polygonal shape, or any other shape; and platform 851 may have a circular shape, an oval shape, a polygonal shape, or any other shape. MEMS mirror 850 and platform 851 may have similar shape (e.g., both have circular shaped) or different shapes (e.g., one has circular shape and one has oval shape). The center of MEMS mirror 850 and platform 851 may or may not be the same. In one example, MEMS mirror 850 and platform 851 may be concentric or eccentric.

MEMS mirror 850 includes a reflective surface that can reflect light. Platform 851 can include a metal-based substrate to provide the mechanical support for MEMS mirror 850. MEMS mirror 850 and platform 851 can be coupled together mechanically (e.g., using screws, fasteners, grooves, clips, brackets, etc.), adhesively, magnetically, or they can form an integral piece.

In some embodiments, at least a part of platform 851 includes a film substrate. A film substrate can be made of glass, ceramics, plastic, polyester, crystal, metal, or composite materials, etc. The film substrate includes, or is physically coupled to, first arm 860 and second arm 861. First arm 860 and second arm 861 are also referred to as left arm and right arm, because they are shown to be positioned to the left and right of platform 851, respectively. In some examples, first arm 860 and second arm 861 are integrated with platform 851, so that they form an integral piece. In other examples, first arm 860 and second arm 861 are detachable from platform 851. In one embodiment, conductive coils 830 are positioned around the left arm 860 and platform 851. The conductive coils 830 are electrically coupled to an electrical source such as a current source or voltage source (not shown in FIG. 8A), to receive current or voltage inputs. The electrical source can be a part of control circuitry 350 shown in FIG. 3 or an independent power source.

When an electrical current “I” (823 and 820) flows through the conductive coils 830, opposite Lorentz forces are applied to the upper and lower portion of platform 851, causing the platform 851 to rotate. As illustrated in FIG. 8A, magnetic field B (821) flows from the north pole 841 to the south pole 842. When the current “I” (823) flows towards the right direction in the upper portion of platform 851, based on Fleming's Left Hand Rule, an upward pointing Lorentz force “F” (824) is applied to the upper portion of platform 851. On the other hand, when current “I” (820) flows towards the left direction in the lower portion of platform 851, a downward pointing Lorentz force “F” (822) is applied to the lower portion of platform 851. The combined forces of 824 and 822 creates a torque, causing platform 851 to rotate along the rotational axis 801 in the direction of 802. Similarly, when the current flows in the opposite direction in conductive coils 830, platform 851 rotates in the opposite direction. By alternating the direction and/or magnitude of the current, platform 851 may oscillate between two positions.

In some embodiments, left arm 860 and right arm 861 are rotatably coupled to support frame 810 via, e.g., bearings (not shown), so that the support frame 810 does not move when platform 851 rotates or oscillates. In other embodiments, left arm 860 and right arm 861 are fixed coupled to support frame 810, so that the support frame 810 also moves when platform 851 moves. In other embodiments, left arm 860 and right arm 861 are rotatably coupled to platform 851 such that platform 851 can move relative to arms 860 and 861.

Arms 860 and 861 supports platform 851 to maintain in its position and to enable platform 851 to rotate or oscillate along axis 801. Arms 860 and 861 overlap with axis 801. In some embodiments, arms 860 and 861 do not overlap with axis 801. In some embodiments, arms 860 and 861 are parallel to each other. In one embodiment, there is only one arm to support platform 851. In some embodiments, arms 860 and 861 are implemented as torsion bars. Arms 860 and 861 not only function as the axis of rotation but also act as torsion springs to suppress the rotation of the mirror. As previously explained, when an electric current flows through the conductive coil 830 in a particular direction, it generates a torque, initiating the rotation of platform 851. Simultaneously, the torsion bar spring exerts an elastic force in the opposite direction, resisting the force of rotation. The rotation of the platform 851 stops when the two forces reach a state of equilibrium. That stop position corresponds to an angular position of the MEMS mirror 850. By adjusting the direction and magnitude of current flowing through the conductive coil 830, MEMS mirror 850 may be controlled to stop at various angular positions. The maximum angular range a MEMS mirror platform may achieve is referred to as the field-of-view of a MEMS mirror apparatus.

The MEMS mirror apparatus 800 depicted in FIG. 8A can only rotate or tilt in one dimension along axis 801. In other embodiments, a MEMS mirror apparatus may have more than one axis and the ability to move or tilt in more than one dimension. FIG. 8B illustrates an exemplary two-dimensional MEMS mirror apparatus 811 according to one embodiment. Apparatus 811 is similar to apparatus 800 but differ in several aspects. Compared to apparatus 800, apparatus 811 includes separate conductive coils 831 situated on the support platform 810. Apparatus 811 also includes two additional arms 862 and 863, which enable the support frame 810 to rotate or tilt along axis 803 in the direction or the opposite direction of 804. The magnetic field B (825) flows diagonally towards support frame 810. In other embodiments, the magnetic field 825 may flow from other directions towards support frame 810. As the magnetic field 825 creates different angles “θ” on different sections of coils 830 and 831, based on formula (1), the diagonally positioned magnetic field 825 enables Lorentz forces to act upon both coils 830 and 831. In some embodiments, currents flowing in each sections of coils 830 and 831 can be controlled separately. While support frame 810 is rotating along axis 803, platform 851 can also rotate along axis 801, thus creating a two-dimensional movement of mirror 850. By controlling the degrees of the rotation or tilt of mirror 850 along the two axes, the LiDAR system's FOV can be expanded to cover a wider angular range in two or more dimensions, e.g., in both vertical and horizontal directions.

Referring back to FIG. 8A, in some embodiments, coils 830 may be electrically coupled to a controller that is configured to regulate the current flowing through coils 830. The controller can either be part of control circuitry 350 depicted in FIG. 3 or an independent circuit. The controller may be configured to control various aspects of the current flowing through coils 830, such as amplitude, intensity, or direction. The controller may manage the voltage, power, or resistance of coils 830. In situations where the current is alternating current (AC), the controller may control the frequency, phase, or impedance, etc., of the current. By controlling these parameters, the controller can control platform 851's angular position and/or movement speed. Consequently, the controller may manage the frame rate, scan speed, scanline density, or region of interest (ROI) of a frame. For example, the controller may control the current flowing through coils 830 so that platform 851 may rotate continuously or incrementally. When rotating incrementally, platform 851 stops at each specific stoppable positions for a brief period. The resolution of angular movement may be fine-tuned by the controller. When platform 851 moves in the vertical dimension of the FOV, the controller may increase the frame rate or scan speed by increasing the vertical movement speed of platform 851. To increase the vertical scanline density across the entire frame or within an ROI, the controller may decrease the vertical movement speed of platform 851. When platform 851 moves in the horizontal dimension of the FOV, the controller may increase the horizontal scan resolution of the entire frame or within an ROI by reducing the horizontal movement speed of platform 851. The controller may also increase the frame rate by increasing the horizontal movement speed of platform 851. For a two-dimensional MEMS mirror apparatus, the controller may simultaneously control the movement speed of platform 851 in both horizontal and vertical directions. For example, the controller may increase the horizontal movement speed to boost the frame rate while decreasing the vertical movement speed to increase the scanline density at the same time. In some situations, this may enable the controller to maintain the frame rate while increasing the scanline density in one or more ROIs within a frame.

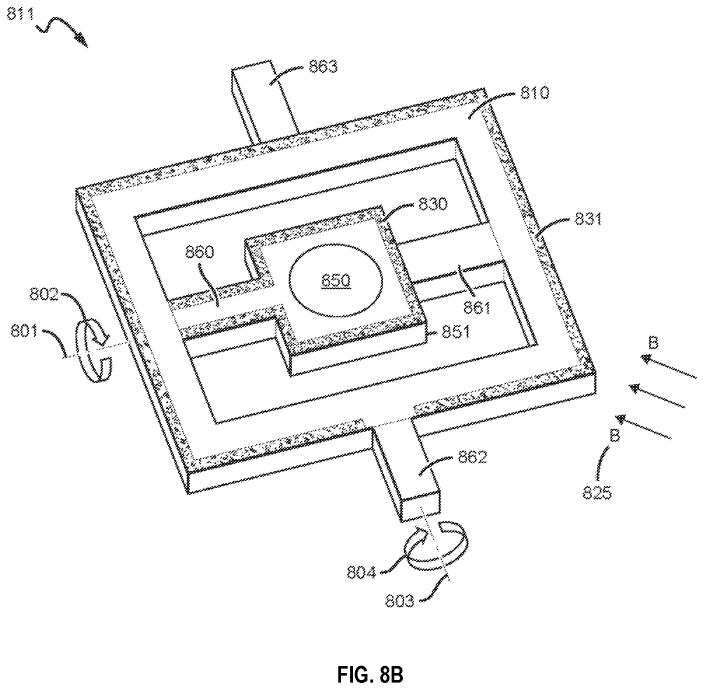

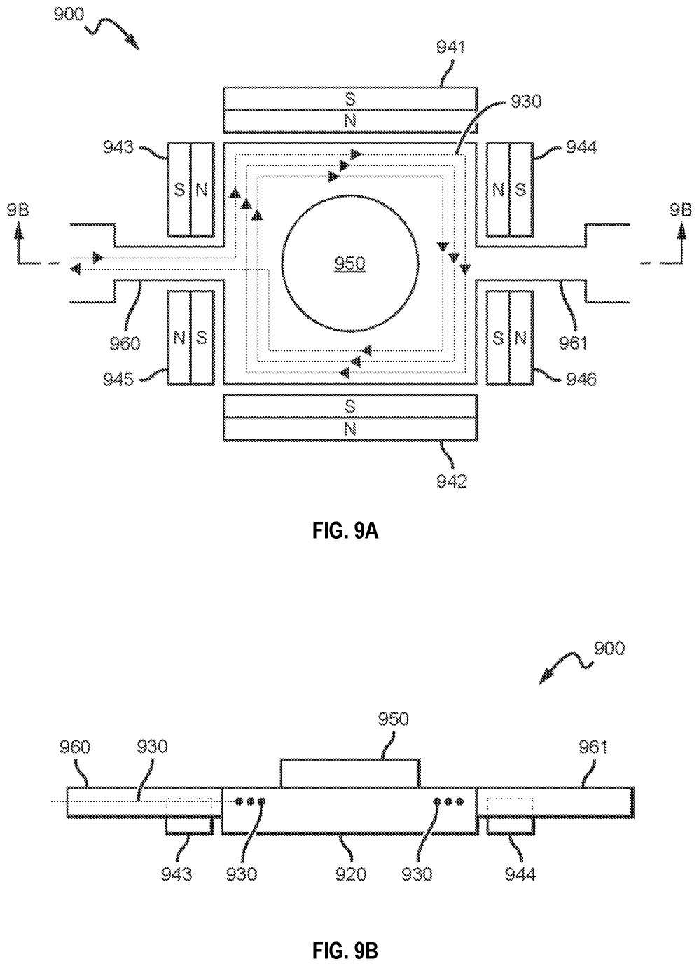

FIGS. 9A and 9B illustrate a top and cross-sectional view of an exemplary MEMS mirror apparatus 900 according to one embodiment. FIG. 9A illustrates a top view of the MEMS mirror apparatus 900. FIG. 9B illustrates a cross-sectional view of the MEMS mirror apparatus 900 along line 9B in FIG. 9A and in the direction indicated. MEMS mirror apparatus 900 is a moveable scanner device, and can be used to implement at least a part of steering mechanism 340 shown in FIG. 3. MEMS mirror apparatus 900 includes mirror 950, platform or substrate 920, left arm 960, right arm 961, magnets 941-946 and coils 930.

Platform 920 is similar to platform 851 of FIG. 8A. Platform 920 assumes a square shape and functions as the substrate for MEMS mirror 950. Platform 920 is sometimes interchangeably referred to as substrate 920 or film substrate 920. In some embodiments, platform 920 incorporates supporting materials, such as plastic materials, to provide additional structural support for the substrate. In some embodiments, MEMS mirror apparatus 900 includes a support frame (not shown in FIG. 9) that is similar to support frame 810 of FIG. 8A. Mirror 950 may be a partial reflection mirror or a full reflection mirror, and is attached to the top of substrate 920. A relatively thin film material is used as substrate 920.

Electrical windings or looped coils 930 are installed in substrate 920. In one embodiment, looped coils 930 are wound on a flat surface. In one embodiment, coils 930 is disposed around the perimeter of mirror 950 and no part of the coils 930 is disposed underneath mirror 950. In other embodiments, at least a part of coils 930 is disposed underneath mirror 950 (not shown in FIG. 9). Coils 930 is coupled to an electrical power supply via arm 960. In some embodiments, coils 930 is coupled to an electrical power supply via arm 961, or via both arms 960 and 961. In some embodiments, coils 930 is coupled to the power supply via electrical nodes situated on one or both arms. In some embodiments, electrical nodes are situated on the support frame of MEMS mirror apparatus 900 (not shown in FIG. 9). In some embodiments, coils 930 is a looped coil and is formed along the edges of the film substrate 920.

In some embodiments, arms 960 and 961 are implemented as torsion bars. As explained previously, an angular position of mirror 950 or platform 920 corresponds to a stop position where the torsion bar spring's torque and elastic force achieve equilibrium. By adjusting the direction and magnitude of current flowing in coils 930, platform 920 may be controlled to stop at various angular positions within its field-of-view. There can be various movement requirements for platform 920. For example, platform 920 may be required to rotate continuously without stopping from one angular position to the next. Platform 920 may also be required to rotate incrementally, stopping at specific stoppable positions for a brief period. The resolution of the angular movement may vary, such as 1 degree, 0.1 degree, 0.01 degree, 0.001 degree, or any other increment value. Platform 920 may also be required to rotate at a certain angular speed, for example, 70 degrees per second, or 120 degrees in 0.1 seconds, etc. Platform 920 may also be required to maintain an average angular speed or limit its rotation to a maximum angular speed.

Specific characteristics of coils and/or magnets, such as the number of windings in coils 930, its dimensions, and the size of magnets (e.g., magnets 941-946), can be configured to meet the movement requirements of platform 920. For example, formula (1) describes the Lorentz force acting on one section of coil based on the conductor's length within the magnetic field. Thus, increasing the number of windings of coils 930 leads to a proportional increase in the applied Lorentz forces on platform 920. Consequently, this enhances the maximum angular speed and/or expands the maximum angular range (hence the field-of-view) of mirror 950. In addition, since Lorentz force is directly proportional to the strength of magnet field, increasing the size or magnet grade of the magnets will also result in higher maximum angular speed and/or a broader field-of-view for mirror 950. The movement requirements of platform 920 may also be controlled by control circuitry 350 shown in FIG. 3. For example, control circuitry 350 may adjust the magnitude and incremental values of the current flowing in coils 930, enabling precise control over the continuous or incremental rotation of platform 920.

In the embodiments shown in FIG. 9A, six permanent magnets, 941-946, are situated in close proximity to the four edges of platform 920. The distance between the permanent magnets to the edges of the platform 920 can be configured based on the desired magnetic field and force. The shorter the distance between opposite magnetic poles, the stronger the magnetic field between the poles. The permanent magnets are not physically attached to platform 920, substrate 920, or mirror 950. In the discussion herein, the “upper” or “lower” half” of platform 920 is referred to the half divided with respect to line 9B. The four edges of platform 920 include the upper edge (the edge closer to magnet 941), the lower edge (the edge closer to magnet 942), the left edge (the edge closer to magnets 943 and 945), and the right edge (the edge closer to magnets 944 and 946). Arms 960 is attached to platform 920's left edge at a substantially center location. Arm 961 is attached to platform's right edge at a substantially center location. The total number of permanent magnets utilized in MEMS mirror apparatus 900 may vary and can exist in any quantity. Furthermore, the number of magnets situated on each side of the platform 920 can differ as well. In addition, the polarity of each magnet may be different than what is currently shown in FIG. 9. Platform 920 assumes a square shape. In some embodiments, platform 920 may adopt alternative shapes, such as a triangle, a rectangular, a parallelogram, a hexagon, or any other polygonal form. Additionally, it is also possible for platform 920 to assume a circular or oval shape. In some embodiments, platform 920 and mirror 950 may have the same shape. In other embodiments, they may have different shapes.

Permanent magnets 941 and 942 are disposed in proximity to the upper and lower edges of platform 920, respectively. They serve similar functions as magnets 841 and 842 in FIG. 8A. The north pole of magnet 941 is closer to the upper edge of platform 920 than its south pole. The south pole of magnet 942 is closer to the lower edge of platform 920 than its north pole. In this configuration, the north pole of magnet 941 faces the south pole of magnet 942, creating a magnetic field that flows from 941 to 942 and across the horizontal coils located on the upper and lower halves of the platform 920. Based on Fleming's Left Hand Rule, the Lorentz force acts on the upper half of platform 920, pointing inwards perpendicular to the paper surface (away from the reader and into the paper). Conversely, the Lorentz force acting on the lower half of platform 920 points outwards towards the reader. These combined forces induce the rotation of platform 920 around the axis defined by line 9B. In some embodiments, arms 960 and 961 align with the axis of line 9B. When the current flows in a reverse direction, platform 920 can rotate or oscillate in the opposite direction.

Four side magnets 943-946 are situated adjacent to the left and right edges of platform 920, with magnets 943 and 945 situated near the left edge, and magnets 944 and 946 situated near the right edge. These side magnets serve to enhance the Lorentz forces exerted on the upper and lower halves of the platform 920, enabling faster rotation and/or a wider angular range. Using the pair of side magnets 943 and 944 in the upper half of platform 920 as an example, the north pole of magnet 943 is closer to the left edge of platform 920 than its south pole. The north pole of magnet 944 is closer to the right edge of platform 920 than its north pole. In this configuration, the north pole of magnet 943 faces the north pole of permanent magnet 944 on the opposite side. As a result of their polarities being against each other, there is no direct magnetic field flowing from magnet 943 to magnet 944. However, in the local region surrounding magnet 943, the magnetic field flows across coils 930 on the left side. Although the magnetic field may not be perpendicular to the direction of the current (θ is not 90 degrees in formula (1)), it still gives rise to a weaker Lorentz force acting on the nearby coils. The same applies to the magnet field in the region near magnet 944. Applying Fleming's Left Hand Rule, these two magnetic fields cause both Lorentz forces to point inwards perpendicular to the paper surface.

Conversely, the south pole of magnet 945 faces the south pole of magnet 946 on the opposing side. Similarly, the opposing polarities of magnets 945 and 946 generate two magnetic fields, which result in a Lorentz force on the nearby coils pointing outwards towards the reader. As the Lorentz forces exerted by the side magnets 943-946 are in the same general direction as the Lorentz forces exerted by the two main magnets 941 and 942, the side magnets serve to enhance the Lorentz forces exerted by magnets 941 and 942. In some embodiments, some or all of magnets 941-946 are electromagnets.

Substrate 920 can be made of a metal-based material. To prevent interference with the magnetic fields generated by surrounding magnets, the film substrate material should be non-magnetic, excluding iron, cobalt, and nickel. To insulate coils 930 from the metal-based substrate, the coil can be sheathed. Various materials, such as polyimide, polyvinyl chloride, or polyester film, can be used for coils 930's sheathing within substrate 920. For the portion of coils 930 outside of substrate 920 (e.g., within arm 960), sheathing may not be necessary. In some embodiments, the entire portion of coils 930 may be sheathed.

Metal-based MEMS substrates offer several advantages over silicon-based substrates. Metal-based MEMS substrates provide higher mechanical strength, leading to more robust and durable MEMS mirrors. Metals have higher flexibility compared to silicon, which is a brittle material. Flexibility allows the metal-based MEMS substrate to bend or deform without fracturing, making it more resilient to mechanical stress. In contrast, silicon-based substrates are prone to cracking or breaking under such conditions.

Metal-based MEMS substrates enable the realization of larger mirror sizes and longer scanning distances. In certain LiDAR systems, larger scanning mirrors contribute to extended scanning distances. When a scanning mirror has a larger surface area, the mirror has a larger optical aperture. In turn, a larger optical aperture allows LiDAR receivers to detect weaker return light signals from objects located at greater distances. Using Silicon as the MEMS substrate imposes limitations on the mirror size, as larger rotating mirrors made of Silicon could be more susceptible to damage. On the other hand, using metal as the MEMS substrate facilitates the creation of larger-sized MEMS mirrors, since metal-based substrate has better resistance to mechanical stresses, vibrations, and shocks.

Metal-based MEMS mirrors also offer the advantage of facilitating larger mirror sizes because of cost considerations. When manufacturing Silicon-based MEMS mirrors on Silicon wafers, achieving high yield is important due to the expensive nature of silicon wafers. Consequently, Silicon-based MEMS chips are typically designed in smaller sizes, aiming for higher yield. For example, a typical Silicon-based MEMS mirror has a diameter of no more than 7 millimeters. On the other hand, using metal as the MEMS substrate allows for production of larger-sized MEMS chips. In some embodiments, the mirror size of metal-based MEMS mirrors can be one inch or more. The cost-effectiveness of metal-based substrates makes it affordable to manufacture larger chips, even with lower yields, compared to the constraints posed by expensive silicon-based substrates.

In some embodiments, film substrate 920 may be bendable or elastic. Film substrate 920 can also be made of polymer-based material. In some embodiments, metal-based film substrate 920 has a thickness of about 1 nanometer to 100 centimeters.

Mirror 950 requires a rigid construction to withstand mechanical stress effectively. Utilizing rigid materials for mirror 950 provides the necessary structural stability, which is important for a robust MEMS mirror. The continuous rotation or oscillation experienced by MEMS mirrors can subject them to mechanical stress. By using rigid materials for mirror 950, the MEMS mirror can maintain its shape, resist deformation, and thereby preserve the mirror's performance and longevity. Silicon or glass can be used as the material of mirror 950.

In some embodiments, to enhance the rigidness of mirror 950, a rigid sheet metal may be attached underneath mirror 950 and installed on top of coils 930. Again, to prevent the sheet metal from interfering with magnetic fields, non-magnetic metal (excluding iron, cobalt, and nickel) can be used as the material of sheet metal. In addition, mirror 950's surface does not necessarily need to be coated or specially treated.

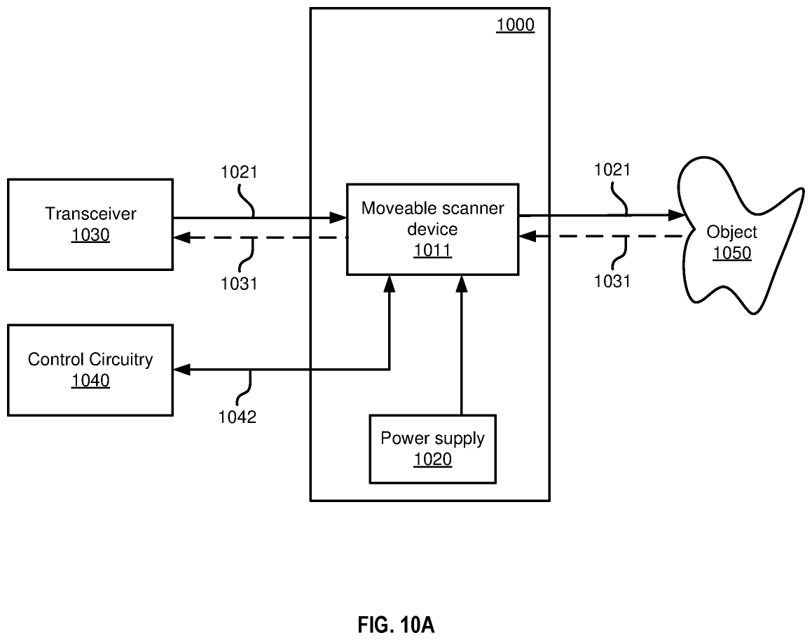

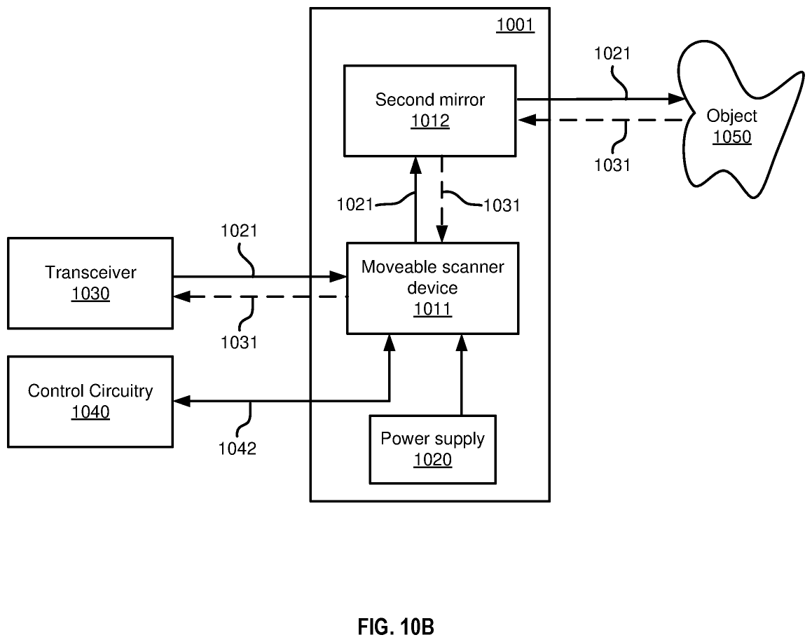

FIG. 10A is a block diagram illustrating an exemplary arrangement of components in a steering mechanism 1000 of a LiDAR system according to one embodiment. Steering mechanism 1000, which is similar to steering mechanism 340 illustrated in FIG. 3, directs light beams from transceiver 1030 to scan an FOV in multiple dimensions (e.g., in horizontal and vertical dimensions). Steering mechanism 1000 includes a moveable scanner device 1001. In some embodiments, moveable scanner device 1011 can be MEMS mirror apparatus 800 depicted in FIG. 8A, or MEMS mirror apparatus 900 depicted in FIG. 9. In some embodiments, moveable scanner device 1011 is a two-dimensional MEMS mirror apparatus.

Transceiver 1030 is the combination of transmitter 320 and optical receiver and light detector 330 depicted in FIG. 3. As illustrated in FIG. 3, transmitter 320 receives laser light from light source 310 and transmits the laser light to steering mechanism 340 via communication path 332. In FIG. 10A, the laser light coming from transmitter 320 via communication path 332 is depicted as outgoing light beam 1021. Outgoing light beam 1021 is directed to moveable scanner device 1011, and then directed by moveable scanner device 1011 to illuminate object 1050 in the FOV. As a two-dimensional MEMS mirror, moveable scanner device 1011 can scan in both horizontal and vertical directions.

Moveable scanner device 1011 is used for both transmitting light beams to illuminate objects in an FOV and for receiving and redirecting return light to transceiver 1030. When outgoing light beam 1021 travels to illuminate object 1050 in the FOV, at least a portion of the light beam is reflected or scattered by object 1050 to form return light 1031. Return light 1031 is received by moveable scanner device 1011, and is then redirected (e.g., reflected) by moveable scanner device 1011 to transceiver 1030 via communication path 352 (shown in FIG. 3).

Control circuitry 1040 functions similarly to control circuitry 350 illustrated in FIG. 3. In this regard, control circuitry 350 establishes communication with the steering mechanism 340 through communication path 342. Likewise, control circuitry 1040 is designed to govern the moveable scanner device 1011 through communication path 1042. For example, it regulates the current flowing in the coils of moveable scanner device 1011 (e.g., coils 830 of MEMS mirror apparatus 800 or coils 930 of MEMS mirror apparatus 900) to manage the MEMS mirror's speed and angular positions. Additionally, control circuitry 1040 receives feedback from moveable scanner device 1011 about the actual mirror speed and position. Based on this feedback, it adjusts the magnitude and incremental values of the current flowing in the coils to fine-tune the movement and/or position of the mirror.

Power supply 1020 is coupled to the coils of moveable scanner device 1011 to provide power for the current to flow in the coils. Power supply 1020 may be an independent power source or a part of control circuitry 1040. In some embodiments, power supply 1040 is controlled by control circuitry 1040.

FIG. 10B is a block diagram illustrating an exemplary arrangement of components in a steering mechanism 1001 of a LiDAR system according to one embodiment. Steering mechanism 1001 is the same as steering mechanism 1000, with the exception that steering mechanism 1001 includes an additional second mirror 1012. Second mirror 1012 can be another MEMS mirror, a polygon mirror, an oscillating mirror, a galvanometer mirror, a rotating prism, rotating tilt mirror surface, or single-plane or multi-plane mirror, etc. Second mirror 1012 may include multiple aforementioned mirrors or a combination thereof.

In steering mechanism 1001, moveable scanner device 1011 may scan in only one direction, and the second mirror 1012 scans in the other direction. For example, moveable scanner device 1011 may scan in the vertical direction of the FOV, and second mirror 1012 scans in the horizontal direction of the FOV. In other embodiments, moveable scanner device 1011 may scan in the horizontal direction and second mirror 1012 may scan in the vertical direction of the FOV. Unlike the steering mechanism 1000 in FIG. 10A, where only the moveable scanner device scans and receives light, in steering mechanism 1001, the outgoing light beam 1021 is directed to moveable scanner device 1011. From there, it is reflected by moveable scanner device 1011 towards the second mirror 1012, which then directs the light to illuminate object 1050 in the FOV. In other embodiments of steering mechanism 1001, the positions of moveable scanner device 1011 and second mirror 1012 may be interchanged.

Both moveable scanner device 1011 and second mirror 1012 are used for transmitting light beams to illuminate objects in an FOV and for receiving and redirecting return light to transceiver 1030. When outgoing light beam 1021 travels to illuminate object 1050 in the FOV, at least a portion of the light beam is reflected or scattered by object 1050 to form return light 1031. Return light 1031 is received by second mirror 1012 and is redirected (e.g., reflected) by second mirror 1012 toward moveable scanner device 1011. Return light 1031 is then redirected (e.g., reflected) by moveable scanner device 1011 to transceiver 1030 via communication path 352 (shown in FIG. 3). In some embodiments, control circuitry 1040 also controls second mirror 1012 and/or power supply 1020 (not shown in FIG. 10B).

The foregoing specification is to be understood as being in every respect illustrative and exemplary, but not restrictive, and the scope of the invention disclosed herein is not to be determined from the specification, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

What is claimed is:

1. An electromagnetically-moveable scanner device for performing light scan used in a light ranging and detection (LiDAR) system, the device comprising:
a platform comprising a film substrate, the platform being pivotable about an axis;
a reflector disposed on the platform;
a plurality of magnets disposed in proximity to one or more edges of the film substrate and detached therefrom; and
one or more electrical windings installed on the platform, at least a part of the electrical windings being disposed underneath the reflector,
wherein when the one or more electrical windings carry electric current, an interaction between magnetic fields formed by the plurality of the magnets and the electrical windings is operative to move the reflector electromagnetically to:
scan transmission light to a field-of-view of the LiDAR system along at least one direction; and
receive return light from the field-of-view, the return light being formed based on the transmission light.

2. The device of claim 1, wherein the film substrate of the platform is made of metal-base material.

3. The device of claim 2, wherein the metal-based material of the substrate comprises non-magnetic metal material.

4. The device of claim 3, wherein the non-magnetic metal material comprises metal material other than iron, nickel, or cobalt.

5. The device of claim 1, wherein the film substrate of the platform has a thickness of approximately 1 nanometer to 100 centimeters.

6. The device of claim 1, wherein the film substrate of the platform is made of polymer-based material.

7. The device of claim 1, wherein the film substrate of the platform is a rigid substrate.

8. The device of claim 1, wherein the film substrate of the platform is a bendable substrate.

9. The device of claim 1, wherein the reflector and the film substrate have substantially the same shape.

10. The device of claim 1, wherein the reflector and the film substrate have different shapes.

11. The device of claim 1, wherein at least one of the reflector and the film substrate has a rectangular shape, a square shape, a round shape, a parallelogram shape, an oval shape, or a polygonal shape.

12. The device of claim 1, wherein the reflector comprises an at least partial reflection mirror.

13. The device of claim 1, wherein the electrical windings comprise looped coils disposed on the film substrate.

14. The device of claim 13, wherein the looped coils are electrically coupled to an electrical power supply via one or more arms attached to the platform.

15. The device of claim 1, wherein the one or more edges of the film substrate comprises a first edge, a second edge, a third edge, and a fourth edge.

16. The device of claim 15, wherein one or more magnets of the plurality of magnets are disposed in proximity to at least one of the first edge and the third edge.

17. The device of claim 16, wherein a first magnet of the one or more magnets is disposed such that a north pole of the first magnet is closer to the first edge than a south pole of the first magnet; and a second magnet of the one or more magnets is disposed such that a south pole of the second magnet is closer to the second edge than a north pole of the second magnet.

18. The device of claim 15, wherein one or more magnets of the plurality of magnets are disposed in proximity to each of the second edge and the fourth edge, wherein at least one of the second edge and the fourth edge is attached to an arm extending away from the film substrate.

19. The device of claim 18, wherein a first magnet of the one or more magnets is disposed such that a north pole of the first magnet is closer to the second edge than a south pole of the first magnet; and a second magnet of the one or more magnets is disposed such that a north pole of the second magnet is closer to a fourth edge than a south pole of the second magnet; and wherein the first magnet and the second magnet are aligned on one side of the axis.

20. The device of claim 19, wherein a third magnet of the one or more magnets is disposed such that a south pole of the third magnet is closer to the second edge than a north pole of the third magnet; and a fourth magnet of the one or more magnets is disposed such that a south pole of the fourth magnet is closer to the fourth edge than a north pole of the fourth magnet; and wherein the third magnet and the fourth magnet are aligned on a second side of the axis.

21. The device of claim 1, wherein the reflector is made of Silicon or glass material.

22. The device of claim 1, further comprising: a rigid sheet metal attached underneath the reflector and installed on top of the coil.

23. The device of claim 22, wherein the rigid sheet metal is made of metal material other than iron, nickel, or cobalt.

24. The device of claim 1, further comprising:
a first arm attached to and extending away from the platform, wherein the first arm is aligned with the axis of the platform, and wherein the platform is configured to rotate or oscillate about the axis using the first arm.

25. The device of claim 24 further comprising:
a second arm attached to and extending away from the platform in an opposite direction of the first arm, wherein the second arm is aligned with the axis of the platform, and wherein the platform is configured to rotate or oscillate about the axis using the first arm and the second arm.

26. The device of claim 25, wherein the first arm and the second arm both overlap with the axis.

27. The device of claim 26, wherein the first arm is attached to the platform at a substantially center position of a first edge of the platform and the second arm is attached to the platform at a substantially center position of a second edge of the platform.

28. The device of claim 1, wherein one or more characteristics of the plurality of magnets and one or more characteristics of the electric windings are configured based on one or more movement requirements of the reflector.
